(19) United States
(12) Patent Application Publication
(10) Pub. No.: US 2021/0320747 A1
(43) Pub. Date: Oct. 14, 2021

(54) USER TERMINAL AND RADIO COMMUNICATION METHOD

(71) Applicant: NTT DOCOMO, INC., Tokyo (JP)

(72) Inventors: Shohei Yoshioka, Tokyo (JP); Kazuki Takeda, Tokyo (JP); Yuki Matsumura, Tokyo (JP); Satoshi Nagata, Tokyo (JP)

(73) Assignee: NTT DOCOMO, INC., Tokyo (JP)

(21) Appl. No.: 17/268,718

(22) PCT Filed: Aug. 17, 2018
(86) PCT No.: PCT/JP2018/030586

§ 371 Date: Feb. 16, 2021

(51) Int. Cl. H04L 1/00; H04L 5/00; H04W 72/12; H04W 72/04

(52) U.S. Cl. CPC H04L 1/0004; H04W 72/0446; H04W 72/1289; H04L 5/0051

(57) ABSTRACT

A user terminal according to one aspect of the present disclosure includes: a receiving section that receives downlink control information for scheduling a downlink shared channel or an uplink shared channel; and a control section that determines a time density of a Phase Tracking Reference Signal (PTRS) based on a plurality of thresholds and a Modulation and Coding Scheme (MCS) index in the downlink control information, wherein the plurality of thresholds is associated with at least one of a table and whether or not transform precoding is applied, and the table is used to determine at least one of a modulation order and a code rate of the downlink shared channel or the uplink shared channel.

### TECHNICAL FIELD

The present disclosure relates to a user terminal and a radio communication method in a next-generation mobile communication system.

### BACKGROUND ART

In UMTS (Universal Mobile Telecommunications System) networks, for the purpose of higher data rates and lower latency, Long Term Evolution (LTE) has been specified (Non-Patent Literature 1). Further, for the purpose of further increasing the capacity and sophistication of LTE (LTE Rel. 8, 9), LTE-A (LTE Advanced, LTE Rel. 10, 11, 12, 13) have been drafted.

The succeeding systems of LTE (which are also referred to as, for example, “FRA (Future Radio Access),” “5G (5th generation mobile communication system),” “5G+(plus),” “NR (New Radio),” “NX (Ne w radio access),” “FX (Future generation radio access),” “LTE Rel. 14” or “LTE Rel. 15 or later vesions” or the like) are also under study.

In the existing LTE system (for example, LTE Rel. 8 to Rel. 14), a user terminal (UE: User Equipment) controls reception of a downlink shared channel (e.g., PDSCH: physical downlink shared channel) based on downlink control information (also referred to as DCI or a Downlink (DL) assignment, etc.) from a base station. Furthermore, the user terminal controls transmission of an uplink shared channel (e.g., PUSCH: Physical Uplink Shared Channel) based on the DCI (also referred to as an Uplink (UL) grant, etc.).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

It is studied for a future radio communication system (e.g., NR) to determine a phase noise by using a Phase Tracking Reference Signal (PTRS), and correct a phase error of at least one of a downlink signal (e.g., downlink shared channel (e.g., PDSCH)) and an uplink signal (e.g., uplink shared channel (e.g., PUSCH)).

Furthermore, it is studied to control a time domain density (time density) of the PTRS based on an index of a Modulation and Coding Scheme (MCS) notified by DCI. However, when the time density of the PTRS is controlled based on the MCS index, there is a risk that a phase noise (phase error) correction effect lowers, or radio resource use efficiency (a data amount that can be transmitted) lowers.

It is therefore one of objects of the present disclosure to provide a user terminal and a radio communication method that can appropriately control a time density of a PTRS.

### Solution to Problem

A user terminal according to one aspect of the present disclosure includes: a receiving section that receives downlink control information for scheduling a downlink shared channel or an uplink shared channel; and a control section that determines a time density of a Phase Tracking Reference Signal (PTRS) based on a plurality of thresholds and a Modulation and Coding Scheme (MCS) index in the downlink control information, wherein the plurality of thresholds is associated with at least one of a table and whether or not transform precoding is applied, and the table is used to determine at least one of a modulation order and a code rate of the downlink shared channel or the uplink shared channel.

### Advantageous Effects of Invention

According to one aspect of the present disclosure, it is possible to appropriately control a time density of a PTRS.

### BRIEF DESCRIPTION OF DRAWINGS

FIG. 1 is a diagram illustrating one example of a first MCS table.

FIG. 2 is a diagram illustrating one example of a second MCS table.

FIG. 3 is a diagram illustrating one example of a third MCS table.

FIG. 4 is a diagram illustrating one example of switching of the first to third MCS tables.

FIG. 5 is a diagram illustrating one example of a time density table.

FIGS. 6A to 6C are diagrams illustrating one example of first to third time density tables according to the present embodiment.

FIGS. 7A and 7B are diagrams illustrating one example of fourth and fifth time density tables according to the present embodiment.

FIG. 8 is a diagram illustrating one example of a schematic configuration of a radio communication system according to the present embodiment.

FIG. 9 is a diagram illustrating one example of an overall configuration of a base station according to the present embodiment.

FIG. 10 is a diagram illustrating one example of a function configuration of the base station according to the present embodiment.

FIG. 11 is a diagram illustrating one example of an overall configuration of a user terminal according to the present embodiment.

FIG. 12 is a diagram illustrating one example of a function configuration of the user terminal according to the present embodiment.

FIG. 13 is a diagram illustrating one example of hardware configurations of the base station and the user terminal according to the present embodiment.

FIG. 14 is a diagram illustrating one example of a fourth MCS table.

FIG. 15 is a diagram illustrating one example of a fifth MCS table.

### DESCRIPTION OF EMBODIMENTS

According to NR, a base station (e.g., gNB) transmits a Phase Tracking Reference Signal (a PTRS or a PT-RS) on DL. The base station may map the PTRS, for example, on a given number of contiguous or non-contiguous Resource Elements (REs) (symbols) in a time direction in a given number of subcarriers to transmit. The base station may transmit the PTRS in at least part of a duration (slots, symbols, and so on) in which a downlink shared channel (PDSCH: Physical Downlink Shared Channel) is transmitted. The PTRS transmitted by the base station (received by a UE) may be referred to as a downlink PTRS.

Furthermore, the UE transmits a Phase Tracking Reference Signal (PTRS) on UL. The UE may map the PTRS, for example, on a given number of contiguous or non-contiguous REs (symbols) in the time direction in a given number of subcarriers to transmit. The UE may transmit the PTRS in at least part of a duration (slots, symbols, and so on) in which an uplink shared channel (PUSCH: Physical Uplink Shared Channel) is transmitted. The PTRS transmitted by the UE (received by the base station) may be referred to as an uplink PTRS.

The UE may decide whether or not the PTRS is present on DL or UL based on configuration information (e.g., PTRS-DownlinkConfig or PTRS-UplinkConfig) by a higher layer signaling. The UE may assume that the PTRS is present in a frequency domain resource (e.g., a Physical Resource Block (PRB) (Resource Block (RB)) or a Resource Block Group (RBG) including one or more RBs) allocated to a PDSCH or a PUSCH.

The UE may determine a phase noise based on the downlink PTRS, and correct a phase error of a downlink signal (e.g., PDSCH). The base station may determine a phase noise based on the uplink PTRS, and correct a phase error of an uplink signal (e.g., PUSCH).

In addition, the higher layer signaling may be one or a combination of, for example, a Radio Resource Control (RRC) signaling, a Medium Access Control (MAC) signaling and broadcast information, and so on.

The MAC signaling may use, for example, an MAC Control Element (MAC CE), an MAC Protocol Data Unit (PDU), and so on. The broadcast information may be, for example, a Master Information Block (MIB), a System Information Block (SIB), Remaining Minimum System Information (RMSI), Other System Information (OSI), and so on.

Furthermore, it is studied for NR to control at least one of a modulation scheme (or a modulation order) and a code rate (modulation order/code rate) of a PDSCH or a PUSCH scheduled by DCI based on a value of a given field (also referred to as, for example, a Modulation and Coding Scheme (MCS) field (e.g., 5 bits) or an MCS index (I_{MCS}) or simply as an index) included in the DCI (e.g., DCI format 0_0, 0_1, 1_0 or 1_1).

More specifically, it is studied that the UE determines the modulation order/code rate associated with the MCS index indicated by the above MCS field in the above DCI for the PUSCH or the PDSCH by using a table (also referred to as, for example, an MCS table, an MCS index table, and so on) that associates MCS indices, and modulation orders and code rates (e.g., target code rates).

In this regard, each modulation order is a value associated with each modulation scheme. For example, modulation orders of Quadrature Phase Shift Keying (QPSK), 16 Quadrature Amplitude Modulation (QAM), 64 QAM and 256 QAM are respectively 2, 4, 6 and 8.

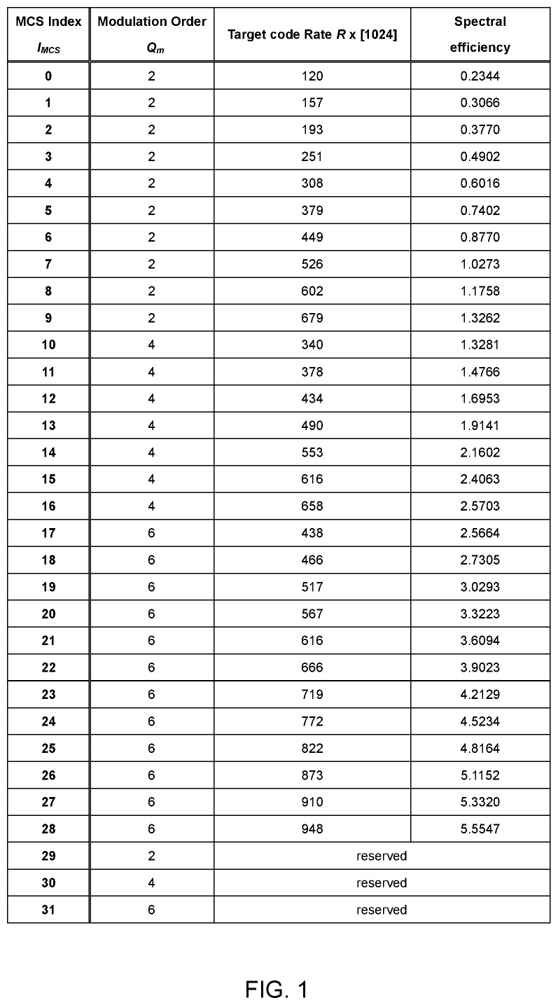

FIGS. 1 to 3 are diagrams illustrating one example of MCS tables. First, second and third MCS tables exemplified in FIGS. 1, 2 and 3 are tables that associate given indices (MCS indices), and modulation orders and code rates (target code rates). In addition, values in the first to third MCS tables illustrated in FIGS. 1 to 3 are only exemplary, and are not limited to these. Furthermore, some items (e.g., spectral efficiency) associated with the MCS index (I_{MCS}) may be omitted, or other items may be added.

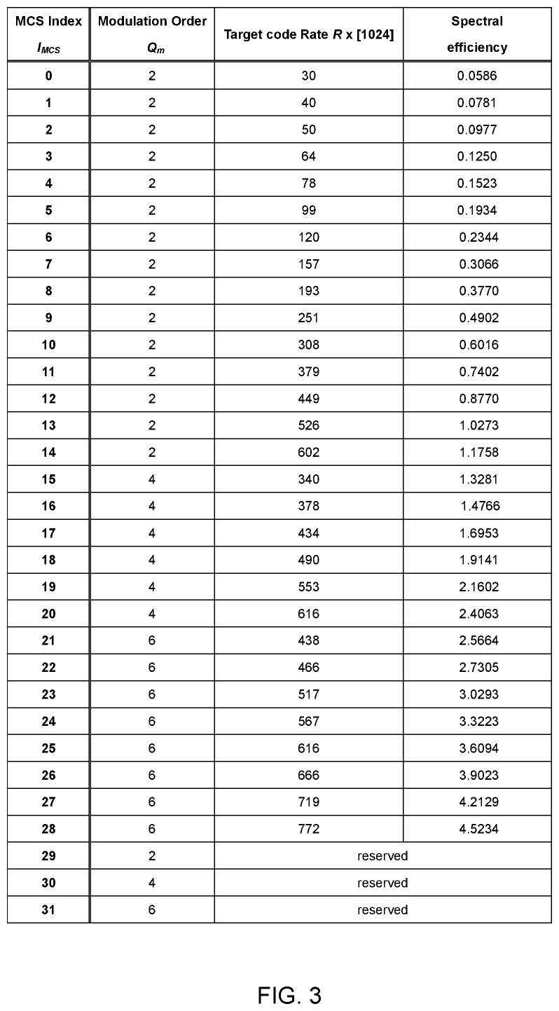

Modulation orders “2”, “4” and “6” are associated with QPSK, 16 QAM and 64 QAM, respectively, in the first and third MCS tables illustrated in FIGS. 1 and 3. At least one of code rates associated with the same modulation order in the third MCS table illustrated in FIG. 3 is smaller than that in the first MCS table illustrated in FIG. 1. The third MCS table may be used in, for example, a case where requirements for latency such as ultra reliability and low latency (e.g., URLLC: Ultra Reliable and Low Latency Communications) is stricter than those in other use cases, or a case where a requirement for reliability is demanded.

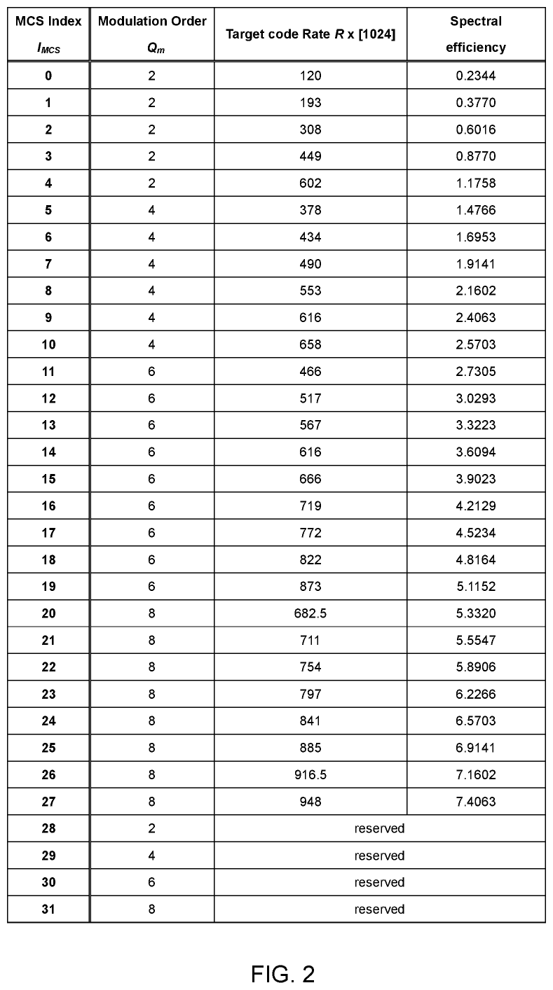

Furthermore, the second MCS table illustrated in FIG. 2 supports a modulation order “8” in addition to the modulation orders “2”, “4” and “6”. The modulation order “8” in modulation order is associated with 256 QAM. The second MCS table may be used in a case where a capacity such as a high speed and a large capacity (e.g., eMBB: enhanced Mobile Broad Band) is demanded. In addition, use cases of the first to third MCS tables are not limited to the above-exemplified use cases.

Furthermore, it is studied for NR that the UE dynamically changes an MCS table used to control a modulation order/code rate of a PDSCH or a PUSCH. More specifically, it is studied that the UE dynamically switches the above first to third MCS tables based on at least one of followings to use to control the modulation order/code rate of the PDSCH or the PUSCH:
Information that indicates one or more MCS tables configured by a higher layer signaling (MCS table information or mcs-Table),
Information that indicates one or more Radio Network Temporary Identifiers (RNTIs) configured by a higher layer signaling (RNTI information),
An RNTI used to scramble (CRC-scramble) a Cyclic Redundancy Check (CRC) bit of DCI,
A DCI format (e.g., one of DCI formats 1_0, 1_1, 0_0 and 0_1),
A search space (e.g., a Common Search Space (CSS) for one or more UEs or a UE-specific Search Space (USS)) in which the DCI is detected, and
Whether or not a transform precoder (transform precoding) is enabled (which one of a Discrete Fourier Transform-Spread-Orthogonal Frequency Division Multiplexing (DFT-spread-OFDM) waveform and a Cyclic Prefix-Orthogonal Frequency Division Multiplexing (CP-OFDM) waveform is used).

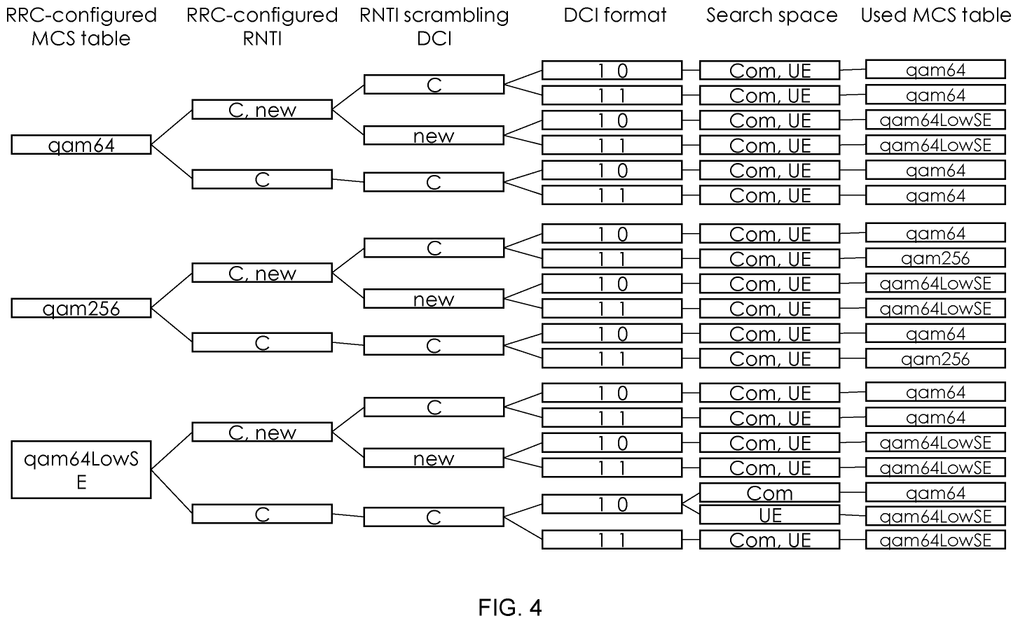

FIG. 4 is a diagram illustrating one example of switching of the first to third MCS tables. For example, FIG. 4 illustrates a case where the first MCS table (qam64), the second MCS table (qam256) and the third MCS table (qam64LowSE) are configured by a higher layer signaling (e.g., RRC signaling) on DL.

Even when, for example, the first MCS table (qam64) is configured by the higher layer signaling as illustrated in FIG. 4, the UE may use, when DCI is CRC-scrambled by a specific RNTI, the third MCS table (qam64LowSE) to control a modulation order/code rate of a PDSCH. The specific RNTI may be referred to as, for example, an RNTI for URLLC, a new RNTI, an MCS RNTI, an mcs-c-RNTI, a URLLC-RNTI, a U-RNTI, a Y-RNTI, an X-RNTI, and so on.

Furthermore, even when the first MCS table (qam64) is configured by the higher layer signaling, the UE may use, when DCI is CRC-scrambled by another RNTI, the first MCS table (qam64) to control the modulation order/code rate of the PDSCH. The another RNTI may be, for example, a Cell-RNTI (C-RNTI), a Temporary Cell RNTI (TC-RNTI), a Configured Scheduling RNTI (CS-RNTI), a System Information RNTI (SI-RNTI), a Random Access RNTI (RA-RNTI) or a Paging RNTI (P-RNTI).

Furthermore, even when the second MCS table (qam256) is configured by the higher layer signaling, the UE may use, when DCI is CRC-scrambled by a specific RNTI, the third MCS table (qam64LowSE) to control a modulation order/code rate of a PDSCH. On the other hand, when the DCI is CRC-scrambled by another RNTI (e.g., C-RNTI), the UE may determine which one of the second MCS table (qam256) and the first MCS table(qam64) to use based on a format of the DCI (e.g., one of the DCI format 1_0 and 1_1). For example, the UE may use the first MCS table (qam64) in a case of the DCI format 1_0, and may use the second MCS table (qam256) in a case of the DCI format 1_1.

Furthermore, even when the third MCS table (qam64LowSE) is configured by the higher layer signaling, the UE may determine, when at least a specific RNTI is configured by the higher layer signaling, the MCS table used to control a modulation order/code rate of a PDSCH based on an RNTI for CRC-scrambling DCI. For example, the UE may use the third MCS table (qam64LowSE) when the DCI is CRC-scrambled by the specific RNTI, and may use the first MCS table (qam64) when the DCI is CRC-scrambled by another RNTI (e.g., C-RNTI).

Furthermore, even when the third MCS table (qam64LowSE) is configured by the higher layer signaling, the UE may determine, when the specific RNTI is not configured by the higher layer signaling, the MCS table used to control the modulation order/code rate of the PDSCH based on at least one of a DCI format and a search space. For example, the UE may use the first MCS table (qam64) when the DCI is the DCI format 1_0 and the DCI is detected in the CSS, and may use the third MCS table (qam64LowSE) when the DCI is detected in the USS. Furthermore, the UE may use the third MCS table (qam64LowSE) when the DCI is the DCI format 1_1.

In addition, FIG. 4 illustrates one example of switching of the first to third MCS tables on DL. However, it is possible to switch the first to third MCS tables on UL, too, based on the above at least one condition. In addition, the switching of the first to third MCS tables may be controlled on UL based on whether or not a transform precoder is enabled.

By the way, it is studied for NR to determine a time domain density (time density) of a PTRS based on a given table and an MCS index in DCI.

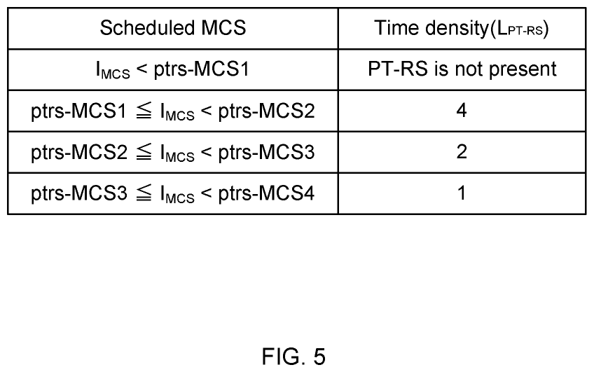

FIG. 5 illustrates a table (also referred to as a time density table) that specifies a correspondence between MCS indices (e.g., MCS index ranges) and PTRS time densities. For example, a set (threshold set) of a given number of thresholds (e.g., four thresholds ptrs-MCS1, ptrs-MCS2, ptrs-MCS3 and ptrs-MCS4) is configured as MCS index thresholds (boundaries) by a higher layer signaling. For example, in FIG. 5, when the MCS index in the DCI is less than ptrs-MCS1,the PTRS is not present.

Furthermore, in FIG. 5, when the MCS index in the DCI is ptrs-MCS1 or more and is less than ptrs-MCS2, the PTRS time density is 4. When the MCS index in the DCI is ptrs-MCS2 or more and is less than ptrs-MCS3, the PTRS time density is 2. When the MCS index in the DCI is ptrs-MCS3 or more and is less than ptrs-MCS4, the PTRS time density is 1. Naturally, the correspondence between the MCS indices and the PTRS time densities is not limited to this.

On the other hand, as described above, it is assumed for NR that the UE dynamically switches MCS tables (e.g., first to third MCS tables) used to control a modulation order/code rate of a PDSCH or a PUSCH. Thus, when a plurality of MCS tables are dynamically switched, and when a PTRS time density is determined by using a single time density table (e.g., a first time density table illustrated in FIG. 5), there is a risk that a phase noise (phase error) correction effect lowers or radio resource use efficiency (a data amount that can be transmitted) lowers.

When, for example, the first MCS table (e.g., FIG. 1) is used, it is assumed that first, second, third and fourth thresholds (ptrs-MCS1, ptrs-MCS2, ptrs-MCS3 and ptrs-MCS4) of the MCS index are 10, 17, 23 and 29, respectively. Performance of a higher modulation order is more sensitive to a phase noise. Hence, these thresholds align with the first MCS table. When, for example, DCI CRC-scrambled by the C-RNTI schedules a PDSCH, and when the MCS index in the DCI is 12 (16 QAM associated with the modulation order “4” according to FIG. 1) (see FIG. 1), a PTRS density is 4 (see FIG. 5).

However, when the third MCS table (e.g., FIG. 3) is used, the modulation order is “2” (QPSK) unlike the first MCS table (e.g., FIG. 1), even when the MCS index in the DCI is 12. In this case, when 4 that is the same PTRS density as that in the case of 16 QAM is applied, there is a risk that a phase noise correction effect lowers due to lack of a PTRS.

On the other hand, when the second MCS table (e.g., FIG. 2) is used, the modulation order is “6” (64 QAM) unlike the first MCS table (e.g., FIG. 1), even when the MCS index in the DCI is 12. In this case, when 4 that is the same PTRS density as that in the case of 16 QAM is applied, there is a risk that radio resource use efficiency (the data amount that can be transmitted) lowers as a result that PTRSs are arranged more than necessary.

Hence, the inventors of the present invention have studied a method for optimizing a PTRS time density when a plurality of MCS tables (e.g., first to third MCS tables) used to control a modulation/code rate of a PDSCH or a PUSCH are dynamically switched, and reached the present invention.

More specifically, the inventors of the present invention have conceived appropriately controlling the PTRS time density by providing a plurality of threshold sets respectively associated with the MCS tables, and using the threshold set associated with the MCS table to be used.

The present embodiment will be described in detail below with reference to the drawings. Aspects according to the present embodiment may be each applied alone or may be applied in combination.

### (First Aspect)

The first aspect will describe reception control of a downlink PTRS.

### <Downlink PTRS Configuration Information>

A user terminal receives configuration information of the downlink PTRS (also referred to as downlink PTRS configuration information, PTRS-DownlinkConfig and so on). For example, the downlink PTRS configuration information may be included in information (also referred to as downlink DMRS configuration information, DMRS-DownlinkConfig and so on) used to configure a Demodulation Reference Signal (DMRS) of a PDSCH. Furthermore, the downlink PTRS configuration information may be configured (notified) to the user terminal by a higher layer signaling.

The downlink PTRS configuration information may include one or more threshold sets used to determine a downlink PTRS time density. For example, the one or more threshold sets may include at least one of first to third threshold sets associated with above first to third MCS tables, respectively.

For example, the first threshold set (timeDensity) associated with the first MCS table (e.g., FIG. 1, qam64) may include a given number of thresholds (e.g., first to fourth thresholds ptrs-MCS1, ptrs-MCS2, ptrs-MCS3 and ptrs-MCS4) of an MCS index.

Furthermore, the second threshold set (timeDensityqam256) associated with the second MCS table (e.g., FIG. 2, qam256) may include a given number of thresholds (e.g., first to fourth thresholds ptrs-MCS1-qam256, ptrs-MCS2-qam256, ptrs-MCS3-qam256 and ptrs-MCS4-qam256 or ptrs-qam256-MCS1, ptrs-qam256-MCS2, ptrs-qam256-MCS3 and ptrs-qam256-MCS4) of the MCS index.

Furthermore, the third threshold set (timeDensityURLLC) associated with the third MCS table (e.g., FIG. 3, qam64LowSE) may include a given number of thresholds (e.g., first to fourth thresholds ptrs-MCS1-URLLC, ptrs-MCS2-URLLC, ptrs-MCS3-URLLC and ptrs-MCS4-URLLC or ptrs-URLLC-MCS1, ptrs-URLLC-MCS2, ptrs-URLLC-MCS3 and ptrs-URLLC-MCS4) of the MCS index.

In addition, all of the numbers of thresholds of the MCS indices included in the first to third threshold sets may be identical, or the numbers of thresholds included in at least part of the threshold sets may be different.

Furthermore, the downlink PTRS configuration information may include information (frequency density information, frequencyDensity) used to determine a downlink PTRS frequency domain density (frequency density).

The above downlink PTRS configuration information may be configured to the user terminal per partial band (Bandwidth Part (BWP)) in a cell, or may be configured to the user terminal commonly to BWPs (specifically to the cell).

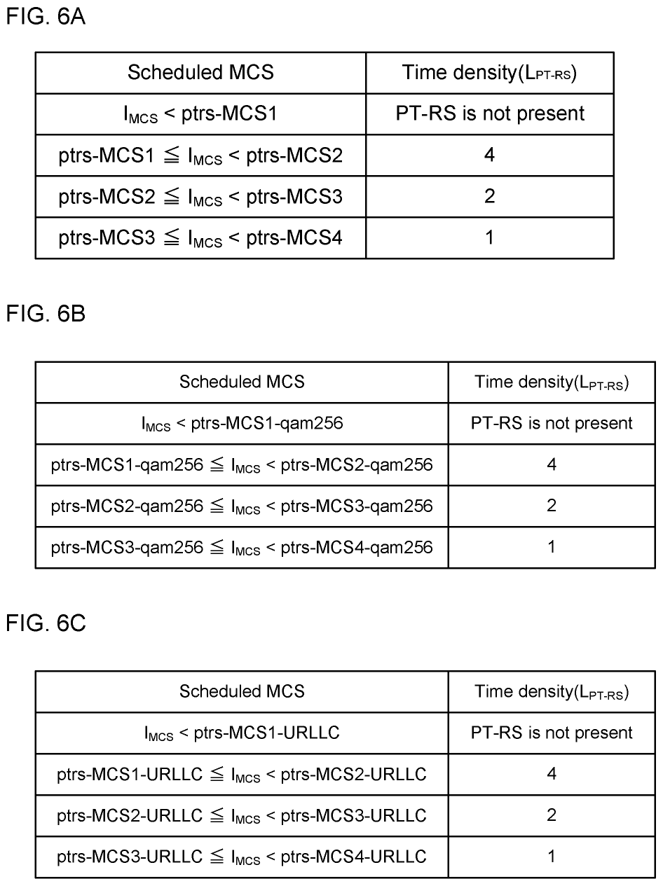

FIGS. 6A to 6C are diagrams illustrating first to third tables (first to third time density tables) that associate MCS indices (e.g., MCS index ranges) and PTRS time densities.

In FIGS. 6A to 6C, the MCS index ranges and the PTRS time densities defined based on the first to third threshold sets may be respectively associated. Values of the first to fourth thresholds included in each of the first to third threshold sets may be different. Hence, in FIGS. 6A to 6C, the MCS index ranges associated with the same time density (e.g., 4) may be different.

### <Downlink PTRS Time Density Determination Procedure>

Next, a downlink PTRS time density determination procedure based on the above downlink PTRS configuration information will be described. According to the determination procedure, DCI may be DCI (a DL assignment or a DCI format 1_0 or 1_1) used to schedule a PDSCH. Furthermore, the DCI may be CRC-scrambled by one of a C-RNTI, an above specific RNTI (e.g., new RNTI), a TC-RNTI, a CS-RNTI, an SI-RNTI, an RA-RNTI and a P-RNTI.

### <<When Downlink PTRS Time Density Is Determined Based on Second Threshold Set>>

When at least one of following conditions is fulfilled, the UE may determine the downlink PTRS time density based on a second threshold set (e.g., the first to fourth thresholds ptrs-MCS1-qam256, ptrs-MCS2-qam256, ptrs-MCS3-qam256 and ptrs-MCS4-qam256) in the downlink PTRS configuration information:
(1) A case where the UE uses the second MCS table (e.g., FIG. 2, qam256) to determine a modulation order/code rate used for a PDSCH,
(2) A case where MCS table information (mcs-Table) in PDSCH configuration information (PDSCH-Config) indicates the second MCS table, the PDSCH is scheduled by DCI (PDCCH) of the DCI format 1_1, and the DCI is CRC-scrambled by a C-RNTI or a CS-RNTI, and
(3) A case where the MCS table information (mcs-Table) is not configured in Semi-Persistent Scheduling (SPS) configuration information (SPS-Config), the MCS table information (mcs-Table) in PDSCH configuration information (PDSCH-Config) indicates the second MCS table, the PDSCH is scheduled (activated) by DCI that is CRC-scrambled by the CS-RNTI, and the PDSCH is allocated by DCI (PDCCH) of the DCI format 1_1.

In addition, at least one of the above PDSCH configuration information (PDSCH-Config) and SPS configuration information (SPS-Config) may be configured to the UE by a higher layer signaling.

Furthermore, SPS is downlink transmission of a given periodicity that uses a frequency domain resource and a time domain resource configured by a higher layer signaling. Activation or deactivation of downlink transmission that uses SPS may be controlled by DCI that is CRC-scrambled by the CS-RNTI.

More specifically, when at least one of the above conditions (1) to (3) is fulfilled, the UE may determine the downlink PTRS time density based on the second time density table (e.g., FIG. 6B) determined based on the above second threshold set, and the MCS index in the DCI.

### <<When Downlink PTRS Time Density Is Determined Based on Third Threshold Set>>

When at least one of following conditions is fulfilled, the UE may determine the downlink PTRS time density based on the third threshold set (e.g., the first to fourth thresholds ptrs-MCS1-URLLC, ptrs-MCS2-URLLC, ptrs-MCS3-URLLC and ptrs-MCS4-URLLC) in the downlink PTRS configuration information:
(1) A case where the UE uses the third MCS table (e.g., FIG. 3, qam64LowSE) to determine a modulation order/code rate used for a PDSCH,
(2) A case where the above specific RNTI is configured to the UE, and the PDSCH is scheduled by DCI that is CRC-scrambled by the above specific RNTI,
(3) A case where the above specific RNTI is not configured to the UE, the MCS table information (mcs-Table) in the PDSCH configuration information (PDSCH-Config) indicates the third MCS table, the PDSCH is scheduled by DCI that is CRC-scrambled by the C-RNTI, and the PDSCH is allocated by DCI (PDCCH) detected in a USS, and
(4) A case where the MCS table information (mcs-Table) in the above SPS configuration information (SPS-Config) indicates the third MCS table, and the PDSCH is scheduled (activated) by DCI that is CRC-scrambled by the CS-RNTI.

In addition, at least one of the above PDSCH configuration information (PDSCH-Config) and SPS configuration information (SPS-Config) may be configured to the UE by a higher layer signaling.

More specifically, when at least one of the above conditions (1) to (4) is fulfilled, the UE may determine the downlink PTRS time density based on the third time density table (e.g., FIG. 6C) determined based on the above third threshold set, and the MCS index in the DCI.

### <<When Downlink PTRS Time Density Is Determined Based on First Threshold Set>>

When at least one of following conditions is fulfilled, the UE may determine the downlink PTRS time density based on the first threshold set (e.g., the first to fourth thresholds ptrs-MCS1, ptrs-MCS2, ptrs-MCS3 and ptrs-MCS4) in the downlink PTRS configuration information:
(1) A case where the UE uses the first MCS table (e.g., FIG. 1, qam64) to determine a modulation order/code rate used for a PDSCH, and
(2) A case where conditions of the second and third threshold sets are not fulfilled.

More specifically, when the above condition (1) is fulfilled, the UE may determine the downlink PTRS time density based on the first time density table (e.g., FIG. 6A) determined based on the above first threshold set, and the MCS index in the DCI.

In addition, the above condition (1) may not be explicitly indicated, and, when the condition to use the above second and third threshold sets is not fulfilled (i.e., otherwise), the UE may determine the uplink PTRS time density based on the above first time density table and the MCS index in the DCI assuming that the above condition (1) is fulfilled.

### <<When First to Third Threshold Sets Are Not Configured>>

When neither one of the first to third thresholds is configured by a higher layer signaling, the UE may assume that the downlink PTRS time density is a given value (e.g., 1).

In the first aspect, the UE may determine a phase noise based on a downlink PTRS whose time density is determined as described above, and correct a phase error of a downlink signal (e.g., PDSCH).

As described above, according to the first aspect, the UE determines the PTRS time density by using a threshold set associated with an MCS table used to determine a modulation order/code rate of a PDSCH. Consequently, when a plurality of MCS tables (e.g., first to third MCS tables) are dynamically switched, it is possible to optimize the downlink PTRS time density, and improve a phase noise (phase error) correction effect.

### (Second Aspect)

The second aspect will describe uplink PTRS transmission control. In addition, the second aspect will mainly describe differences from the first aspect.

### <Uplink PTRS Configuration Information>

A user terminal receives configuration information of an uplink PTRS (also referred to as, for example, uplink PTRS configuration information, PTRS-UplinkConfig and so on). For example, the uplink PTRS configuration information may be included in information (also referred to as, for example, uplink DMRS configuration information, DMRS-UplinkConfig and so on) used to configure a Demodulation Reference Signal (DMRS) of a PUSCH. Furthermore, the uplink PTRS configuration information may be configured (notified) to the user terminal by a higher layer signaling.

The uplink PTRS configuration information may include one or more threshold sets used to determine an uplink PTRS time density. More specifically, the one or more threshold sets may be defined based on at least one of an MCS table and whether or not a transform precoder is enabled (whether or not transform precoding is applied, and which one of an uplink signal waveform, a DFT-spared-OFDM waveform and a CP-OFDM waveform is used).

In addition, the same MCS table (e.g., FIG. 2) as that on DL may be used on UL for a second MCS table irrespectively of whether or not the transform precoder is enabled. On the other hand, when transform precoding is applied, fourth and fifth MCS tables different from those on DL may be used for MCS tables (above first and third MCS tables) that support the modulation orders “2”, “4” and “6” and do not support the modulation order “8”. When transform precoding is not applied, the first and third MCS tables may be used similar to DL.

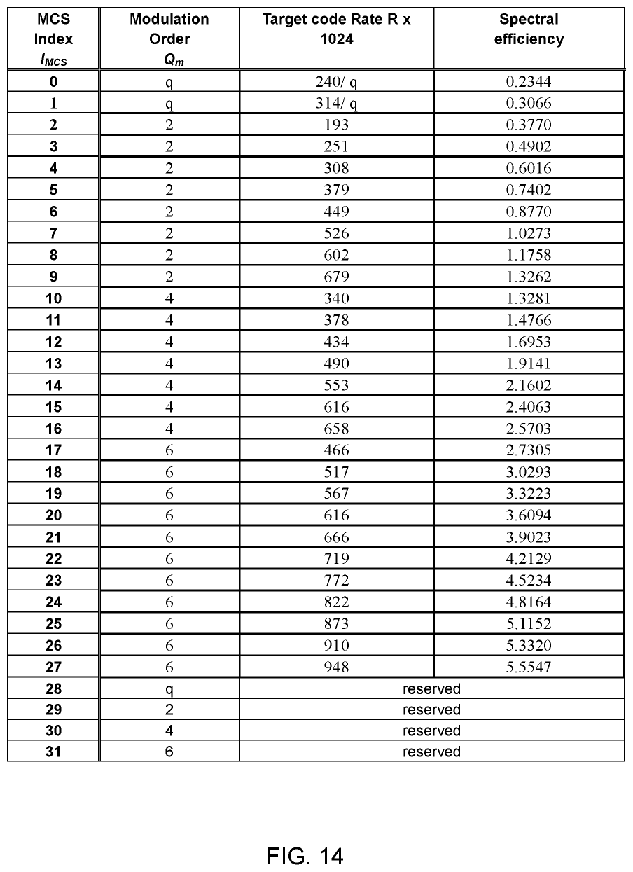

FIG. 14 is a diagram illustrating one example of the fourth MCS table. In FIG. 14, when a higher layer parameter (e.g., PUSCH-tp-pi2BPSK or tp-pi2PBSK) that indicates that the transform precoder is enabled and Binary Phase Shift Keying (BPSK) is applied is configured, q=1 holds. When the higher layer parameter is not configured, q=2 holds. In a case of q=1, modulation orders associated with MCS Indices “0” and “1” are “1”. In addition, the modulation order “1” is associated with BPSK. On the other hand, in a case of q=2, modulation orders associated with MCS Indices “0” and “1” are “2”.

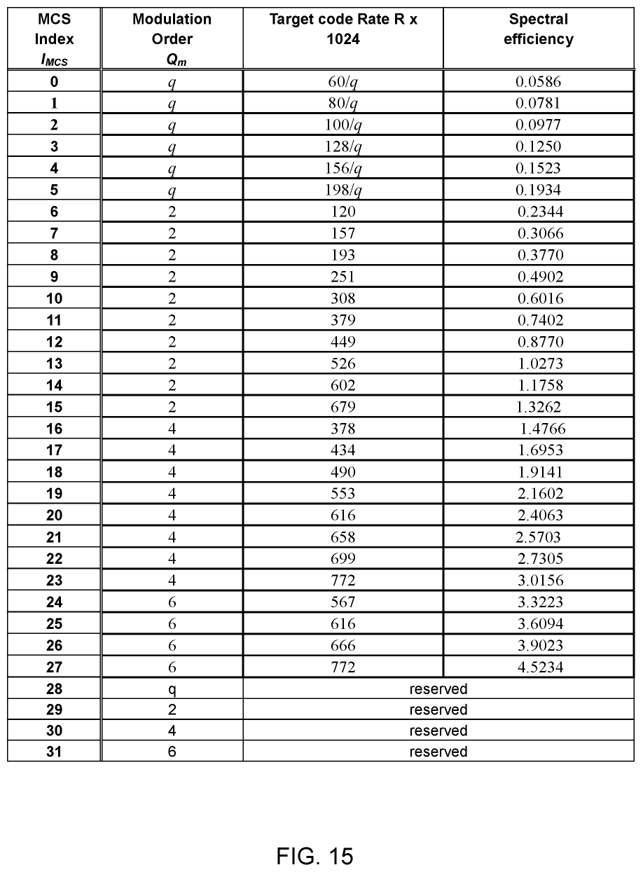

FIG. 15 is a diagram illustrating one example of the fifth MCS table. In FIG. 15, when a higher layer parameter (e.g., PUSCH-tp-pi2BPSK or tp-pi2PBSK) that indicates that the transform precoder is enabled and BPSK is applied is configured, q=1 holds. When the higher layer parameter is not configured, q=2 holds. In a case of q=1, modulation orders associated with MCS Indices “0” to “5” are “1”. On the other hand, in a case of q=2, modulation orders associated with MCS Indices “0” to “5” are “2”.

For example, the one or more threshold sets may be at least one of first to fifth threshold sets.

For example, the first threshold set (timeDensity) associated with the first MCS table (e.g., FIG. 1) in a case where transform precoding is not applied may include a given number of thresholds (e.g., first to fourth thresholds ptrs-MCS1, ptrs-MCS2, ptrs-MCS3 and ptrs-MCS4) of the MCS index.

Furthermore, the second threshold set (timeDensityqam256) associated with the second MCS table (e.g., FIG. 2) may include a given number of thresholds (e.g., first to fourth thresholds ptrs-MCS1-qam256, ptrs-MCS2-qam256,ptrs-MCS3-qam256 and ptrs-MCS4-qam256 or ptrs-qam256-MCS1, ptrs-qam256-MCS2, ptrs-qam256-MCS3 and ptrs-qam256-MCS4) of the MCS index.

Furthermore, the third threshold set (timeDensityURLLC) associated with the third MCS table (e.g., FIG. 3) in a case where transform precoding is not applied may include a given number of thresholds (e.g., first to fourth thresholds ptrs-MCS1-URLLC, ptrs-MCS2-URLLC, ptrs-MCS3-URLLC and ptrs-MCS4-URLLC or ptrs-URLLC-MCS1, ptrs-URLLC-MCS2, ptrs-URLLC-MCS3 and ptrs-URLLC-MCS4) of the MCS index.

For example, the fourth threshold set (timeDensitypi2BPSK) associated with the fourth MCS table (e.g., FIG. 14) in a case where transform precoding is applied may include a given number of thresholds (e.g., first to fourth thresholds ptrs-MCS1-pi2BPSK, ptrs-MCS2-pi2BPSK, ptrs-MCS3-pi2BPSK and ptrs-MCS4-pi2BPSK or ptrs-pi2BPSK-MCS1, ptrs-pi2BPSK-MCS2, ptrs-pi2BPSK-MCS3 and ptrs-pi2BPSK-MCS4) of the MCS index. In addition, different values may be configured to the fourth threshold set according to whether or not the higher layer parameter (e.g., PUSCH-tp-pi2BPSK or tp-pi2PBSK) is configured. Furthermore, both of a threshold set in a case where the higher layer parameter is configured, and a threshold set in a case where the higher layer parameter is not configured may be included in the uplink PTRS configuration information.

Furthermore, the fifth threshold set (timeDensitypi2BPSKURLLC) associated with the fifth MCS table (e.g., FIG. 15) in a case where transform precoding is applied may include a given number of thresholds (e.g., first to fourth thresholds ptrs-MCS1-URLLC, ptrs-MCS2-pi2BPSK-URLLC, ptrs-MCS3-pi2BPSK-URLLC and ptrs-MCS4-pi2BPSK-URLLC or ptrs-pi2BPSK-URLLC-MCS1, ptrs-pi2BPSK-URLLC-MCS2, ptrs-pi2BPSK-URLLC-MCS3 and ptrs-pi2BPSK-URLLC-MCS4) of the MCS index. In addition, different values may be configured to the fifth threshold set according to whether or not the higher layer parameter (e.g., PUSCH-tp-pi2BPSK or tp-pi2PBSK) is configured. Furthermore, both of a threshold set in a case where the higher layer parameter is configured, and a threshold set in a case where the higher layer parameter is not configured may be included in the uplink PTRS configuration information.

In addition, all of the numbers of thresholds of the MCS indices included in the first to fifth threshold sets may be identical, or the numbers of thresholds included in at least part of threshold sets may be different. In addition, the second MCS table may be commonly used between DL and UL. However, a sixth MCS table that supports the modulation order “8” for UL may be used instead of the second MCS table.

Furthermore, the uplink PTRS configuration information may include information (frequency density information, frequencyDensity) used to determine an uplink PTRS frequency density.

The above uplink PTRS configuration information may be configured to the user terminal per BWP in a cell, or may be configured to the user terminal commonly to BWPs (specifically to the cell).

As described with reference to FIGS. 6A to 6C, first to third time density tables that associate MCS index ranges and PTRS time densities defined based on the first to third threshold sets may be provided.

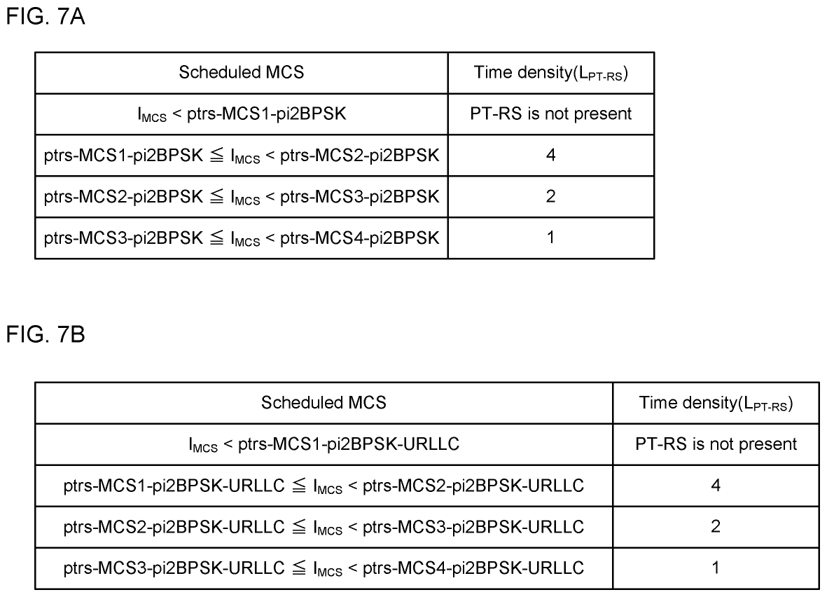

Furthermore, as described with reference to FIGS. 7A and 7B, fourth and fifth tables (fourth and fifth time density tables) that associate MCS index ranges and PTRS time densities defined based on the fourth and fifth threshold sets may be provided.

In addition, values of the first to fourth thresholds included in each of the first to fifth threshold sets may be different. Hence, the MCS index ranges associated with the same time density (e.g., 4) may be different in FIGS. 6A to 6C and FIGS. 7A and 7B.

### <Uplink PTRS Time Density Determination Procedure>

Next, an uplink PTRS time density determination procedure based on the above uplink PTRS configuration information will be described. According to the determination procedure, DCI may be DCI (a UL grant or a DCI format 0_0 or 0_1) used to schedule a PUSCH, or may be DCI (Random Access Response (RAR) UL grant) used to schedule a PUSCH for sending an RAR message.

Furthermore, the DCI may be CRC-scrambled by one of a C-RNTI, an above specific RNTI (e.g., new RNTI), a TC-RNTI, a CS-RNTI, an SI-RNTI, a Semi-Persistent Channel State Information RNTI (SP-CSI-RNTI) and a Configured Scheduling RNTI (CS-RNTI).

### <<When Transform Precoder Is Not Enabled, and Uplink PTRS Time Density Is Determined Based on Second Threshold Set>>

When the transform precoder is not enabled, and at least one of following conditions is fulfilled, the UE may determine the uplink PTRS time density based on the second threshold set (e.g., the first to fourth thresholds ptrs-MCS1-qam256, ptrs-MCS2-qam256, ptrs-MCS3-qam256 and ptrs-MCS4-qam256) in the uplink PTRS configuration information:
(1) A case where the UE uses the second MCS table (e.g., FIG. 2, qam256) to determine a modulation order/code rate used for a PUSCH,
(2) A case where MCS table information (mcs-Table) in PUSCH configuration information (PUSCH-Config) indicates the second MCS table, the PUSCH is scheduled by DCI (PDCCH) of the DCI format 0_1, and the DCI is CRC-scrambled by a C-RNTI or an SP-CSI-RNTI, and
(3) A case where the MCS table information (mcs-Table) is indicated in configured grant configuration information (ConfiguredGrantConfig) (mcs-Table indicates 256 QAM), and the PUSCH is scheduled (activated) by DCI that is CRC-scrambled by the CS-RNTI.

In addition, at least one of the above PUSCH configuration information (PUSCH-Config) and configured grant configuration information (ConfiguredGrantConfig) may be configured to the UE by a higher layer signaling.

Furthermore, the configured grant is uplink transmission of a given periodicity that uses a frequency domain resource and a time domain resource configured by a higher layer signaling, and is also referred to as, for example, grant-free transmission. Activation or deactivation of uplink transmission that uses the configured grant may be controlled by DCI that is CRC-scrambled by the CS-RNTI.

More specifically, when at least one of the above conditions (1) to (3) is fulfilled, the UE may determine the uplink PTRS time density based on the second time density table (e.g., FIG. 6B) determined based on the above second threshold set, and the MCS index in the DCI.

### <<When Transform Precoder Is Not Enabled, and Uplink PTRS Time Density Is Determined Based on Third Threshold Set>>

When the transform precoder is not enabled, and at least one of following conditions is fulfilled, the UE may determine the uplink PTRS time density based on the third threshold set (e.g., the first to fourth thresholds ptrs-MCS1-URLLC, ptrs-MCS2-URLLC, ptrs-MCS3-URLLC and ptrs-MCS4-URLLC) in the uplink PTRS configuration information:
(1) A case where the UE uses the fourth MCS table (q=2) (e.g., FIG. 15) to determine a modulation order/code rate used for a PUSCH,
(2) A case where the above specific RNTI is configured to the UE, and the PUSCH is scheduled by DCI that is CRC-scrambled by the above specific RNTI,
(3) A case where the above specific RNTI is not configured to the UE, the MCS table information (mcs-Table) in the PUSCH configuration information (PUSCH-Config) indicates the fourth MCS table (q=2) (or mcs-Table is not present in the PUSCH configuration information), the PUSCH is scheduled by DCI that is CRC-scrambled by the C-RNTI or the SP-CSI-RNTI, and the PUSCH is allocated by DCI (PDCCH) detected in a USS, and
(4) A case where the MCS table information (mcs-Table) in the above configured grant configuration information (ConfiguredGrantConfig) indicates the fourth MCS table (q=2) (or mcs-Table is not present in the configured grant configuration information), and the PUSCH is scheduled (activated) by DCI that is CRC-scrambled by the CS-RNTI.

In addition, at least one of the above PUSCH configuration information (PUSCH-Config) and configured grant configuration information (ConfiguredGrantConfig) may be configured to the UE by a higher layer signaling.

More specifically, when at least one of the above conditions (1) to (4) is fulfilled, the UE may determine the uplink PTRS time density based on the third time density table (e.g., FIG. 6C) determined based on the above third threshold set, and the MCS index in the DCI.

### <<When Transform Precoder is Not Enabled, and Uplink PTRS Time Density is Determined Based on First Threshold Set>>

When the transform precoder is not enabled, and at least one of following conditions is fulfilled, the UE may determine the uplink PTRS time density based on the first threshold set (e.g., the first to fourth thresholds ptrs-MCS1, ptrs-MCS2, ptrs-MCS3 and ptrs-MCS4) in the uplink PTRS configuration information:
(1) A case where the UE uses the fourth MCS table (q=2) (e.g., FIG. 14) to determine a modulation order/code rate used for a PUSCH, and
(2) A case where conditions of the second and third threshold sets are not fulfilled.

More specifically, when the above condition (1) is fulfilled, the UE may determine the uplink PTRS time density based on the first time density table (e.g., FIG. 6A) determined based on the above first threshold set, and the MCS index in the DCI.

In addition, the above condition (1) may not be explicitly indicated, and, when the transform precoder is not enabled, and the condition to use the above third and second threshold sets is not fulfilled (i.e., otherwise), the UE may determine the uplink PTRS time density based on the above first time density table and the MCS index in the DCI assuming that the above condition (1) is fulfilled.

### <<When Transform Precoder Is Enabled, and Uplink PTRS Time Density Is Determined Based on Second Threshold Set>>

When the transform precoder is enabled, and at least one of following conditions is fulfilled, the UE may determine the uplink PTRS time density based on the second threshold set (e.g., the first to fourth thresholds ptrs-MCS1-qam256, ptrs-MCS2-qam256, ptrs-MCS3-qam256 and ptrs-MCS4-qam256) in the uplink PTRS configuration information:
(1) A case where the UE uses the second MCS table (e.g., FIG. 2, qam256) to determine a modulation order/code rate used for a PUSCH,
(2) A case where information (TransFormPrecoder (TFP) MCS table information or mcs-TableTransformPrecoder) in PUSCH configuration information (PUSCH-Config) that indicates an MCS table in a case where the transform precoder is enabled, indicates the second MCS table, the PUSCH is scheduled by DCI (PDCCH) of the DCI format 0_1, and the DCI is CRC-scrambled by a C-RNTI or an SP-CSI-RNTI, and
(3) A case where the TFP MCS table information (mcs-TableTransformPrecoder) is indicated in configured grant configuration information (ConfiguredGrantConfig), and the PUSCH is scheduled (activated) by DCI that is CRC-scrambled by the CS-RNTI.

In addition, at least one of the above PUSCH configuration information (PUSCH-Config) and configured grant configuration information (ConfiguredGrantConfig) may be configured to the UE by a higher layer signaling.

More specifically, when at least one of the above conditions (1) to (3) is fulfilled, the UE may determine the uplink PTRS time density based on the second time density table (e.g., FIG. 6B) determined based on the above second threshold set, and the MCS index in the DCI.

### <<When Transform Precoder is Enabled, and Uplink PTRS Time Density is Determined Based on Fifth Threshold Set>>

When the transform precoder is enabled, and at least one of following conditions is fulfilled, the UE may determine the uplink PTRS time density based on the fifth threshold set (e.g., the first to fourth thresholds ptrs-MCS1-pi2BPSK-URLLC, ptrs-MCS2-pi2BPSK-URLLC, ptrs-MCS3-pi2BPSK-URLLC and ptrs-MCS4-pi2BPSK-URLLC) in the uplink PTRS configuration information:
(1) A case where the UE uses the fifth MCS table (q=1) (e.g., FIG. 15) to determine a modulation order/code rate used for a PUSCH,
(2) A case where the above specific RNTI is configured to the UE, and the PUSCH is scheduled by DCI that is CRC-scrambled by the above specific RNTI,
(3) A case where the above specific RNTI is not configured to the UE, the TFP MCS table information (mcs-TableTransformPrecoder) in the PUSCH configuration information (PUSCH-Config) indicates the fifth MCS table (q=1) (or mcs-TableTransformPrecoder is not present in the PUSCH configuration information), the PUSCH is scheduled by DCI that is CRC-scrambled by the C-RNTI and the SP-CSI-RNTI, and the PUSCH is allocated by DCI (PDCCH) detected in a USS, and
(4) A case where the TFP MCS table information (mcs-TableTransformPrecoder) in the above configured grant configuration information (ConfiguredGrantConfig) indicates the fifth MCS table (q=1) (or mcs-TableTransformPrecoder is not present in the configured grant configuration information), and the PUSCH is scheduled (activated) by DCI that is CRC-scrambled by the CS-RNTI.

In addition, at least one of the above PUSCH configuration information (PUSCH-Config) and configured grant configuration information (ConfiguredGrantConfig) may be configured to the UE by a higher layer signaling.

More specifically, when at least one of the above conditions (1) to (4) is fulfilled, the UE may determine the uplink PTRS time density based on the fifth time density table (e.g., FIG. 7B) determined based on the above fifth threshold set, and the MCS index in the DCI.

### <<When Transform Precoder Is Enabled, and Uplink PTRS Time Density Is Determined Based on Fourth Threshold Set>>

When the transform precoder is enabled, and at least one of following conditions is fulfilled, the UE may determine the uplink PTRS time density based on the fourth threshold set (e.g., the first to fourth thresholds ptrs-MCS1-pi2BPSK, ptrs-MCS2-pi2BPSK, ptrs-MCS3-pi2BPSK and ptrs-MCS4-pi2BPSK) in the uplink PTRS configuration information:
(1) A case where the UE uses the fourth MCS table (e.g., FIG. 14) to determine a modulation order/code rate used for a PUSCH, and
(2) A case where conditions of the second and fifth threshold sets are not fulfilled.

More specifically, when the above condition (1) is fulfilled, the UE may determine the uplink PTRS time density based on the fourth time density table (e.g., FIG. 7A) determined based on the above fourth threshold set, and the MCS index in the DCI.

In addition, the above condition (1) may not be explicitly indicated, and, when the transform precoder is not enabled, and the condition to use the above second and fifth threshold sets is not fulfilled (i.e., otherwise), the UE may determine the uplink PTRS time density based on the above fourth time density table and the MCS index in the DCI assuming that the above condition (1) is fulfilled.

### <<When First to Third Threshold Sets Are Not Configured>>

When neither one of the first to fifth thresholds is configured by a higher layer signaling, the UE may assume that the uplink PTRS time density is a given value (e.g., 1).

In the second aspect, the UE may determine an uplink PTRS time density as described above, and map the uplink PTRS on an RE based on the determined time density to transmit. The base station may determine a phase noise based on the uplink PTRS, and correct a phase error of an uplink signal (e.g., PUSCH).

As described above, according to the second aspect, the UE determines the PTRS time density by using a threshold set associated with at least one of whether or not the transform precoder is enabled and an MCS table. Consequently, when a plurality of MCS tables (e.g., first to third MCS tables) are dynamically switched, it is possible to optimize the uplink PTRS time density, and improve a phase noise (phase error) correction effect.

### (Other Aspect)

First to fifth time density tables illustrated in FIGS. 6A to 6C, 7A and 7B are only exemplary, and are not limited to these. For example, at least one of the numbers of rows of the first to fifth time density tables may not be 4, and may be, for example, 2, 6 or 8. Furthermore, the numbers of thresholds used between the first to fifth time density tables may be identical or may be different.

Furthermore, each value of first to third threshold sets included in downlink PTRS configuration information, and each value of first to third threshold sets included in uplink PTRS configuration information may be identical, or may be different.

Furthermore, not only the above threshold sets of MCS indices, but also the other parameters may be configured in association with MCS tables and whether or not transform precoding is applied. For example, the other parameters may include, for example, recommendation information (PTRS -Den sityRecommendationDL, PTRS-DensityRecommendationUL and so on) related to a PTRS density.

In this regard, a condition regarding which threshold set (MCS table) described in the first and second aspects to use is not limited to above conditions. For example, decision on whether or not a PUSCH is scheduled by DCI (PDCCH) detected in a USS may be added to decision on which one of a second MCS table and a third MCS table to use. Furthermore, a condition to dynamically switch the MCS table is not limited to above conditions, and may be any condition.

### (Radio Communication System)

The configuration of the radio communication system according to the embodiment of the present disclosure will be described below. This radio communication system uses at least one or a combination of the radio communication method described in the above embodiment to perform communication.

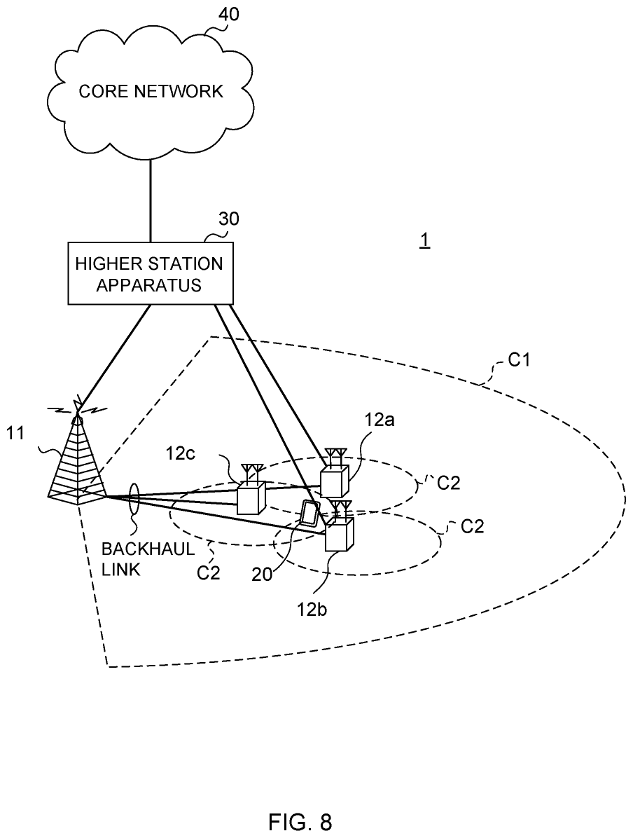

FIG. 8 is a diagram illustrating one example of a schematic configuration of the radio communication system according to the present embodiment. A radio communication system 1 can apply Carrier Aggregation (CA) and/or Dual Connectivity (DC) that aggregate a plurality of component carriers (cells or carriers).

In this regard, the radio communication system 1 may be referred to as Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), New Radio (NR), Future Radio Access (FRA), the New Radio Access Technology (New-RAT) and 5G+, or a system that realizes these techniques.

Furthermore, the radio communication system 1 may support dual connectivity between a plurality of Radio Access Technologies (RATs) (Multi-RAT Dual Connectivity (MR-DC)). MR-DC may include, for example, dual connectivity of LTE and NR (EN-DC: E-UTRA-NR Dual Connectivity) where a base station (eNB) of LTE (E-UTRA) is a Master Node (MN), and a base station (gNB) of NR is a Secondary Node (SN), and dual connectivity of NR and LTE (NE-DC: NR-E-UTRA Dual Connectivity) where a base station (gNB) of NR is an MN, and a base station (eNB) of LTE (E-UTRA) is an SN.

The radio communication system 1 includes a base station 11 that forms a macro cell C1 of a relatively wide coverage, and base stations 12 (12a to 12c) that are located in the macro cell Cl and form small cells C2 narrower than the macro cell C1. Furthermore, a user terminal 20 is located in the macro cell C1 and each small cell C2. An arrangement and the numbers of respective cells and the user terminals 20 are not limited to the aspect illustrated in FIG. 8.

The user terminal 20 can connect with both of the base station 11 and the base stations 12. The user terminal 20 is assumed to concurrently use the macro cell C1 and the small cells C2 by using CA or DC. Furthermore, the user terminal 20 can apply CA or DC by using a plurality of cells (CCs) (e.g., five CCs or less or six CCs or more).

The user terminal 20 and the base station 11 can communicate by using a carrier (also referred to as a legacy carrier) of a narrow bandwidth in a relatively low frequency band (e.g., 2 GHz). On the other hand, the user terminal 20 and each base station 12 may use a carrier of a wide bandwidth in a relatively high frequency band (e.g., 3.5 GHz or 5 GHz) or may use the same carrier as that used between the user terminal 20 and the base station 11. In this regard, a configuration of the frequency band used by each base station is not limited to this.

Furthermore, the user terminal 20 can perform communication by using Time Division Duplex (TDD) and/or Frequency Division Duplex (FDD) in each cell. Furthermore, each cell (carrier) may be applied a single numerology or may be applied a plurality of different numerologies.

The numerology may be a communication parameter to be applied to transmission and/or reception of a certain signal and/or channel, and may indicate at least one of, for example, a subcarrier spacing, a bandwidth, a symbol length, a cyclic prefix length, a subframe length, a TTI length, the number of symbols per TTI, a radio frame configuration, specific filtering processing performed by a transceiver in a frequency domain, and specific windowing processing performed by the transceiver in a time domain.

For example, a case where subcarrier spacings of constituent OFDM symbols are different and/or a case where the numbers of OFDM symbols are different on a certain physical channel may be read as that numerologies are different.

The base station 11 and each base station 12 (or the two base stations 12) may be connected by way of wired connection (e.g., optical fibers compliant with a Common Public Radio Interface (CPRI) or an X2 interface) or radio connection.

The base station 11 and each base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each base station 12 may be connected with the higher station apparatus 30 via the base station 11.

In this regard, the base station 11 is a base station that has a relatively wide coverage, and may be referred to as a macro base station, an aggregate node, an eNodeB (eNB) or a transmission/reception point. Furthermore, each base station 12 is a base station that has a local coverage, and may be referred to as a small base station, a micro base station, a pico base station, a femto base station, a Home eNodeB (HeNB), a Remote Radio Head (RRH) or a transmission/reception point. The base stations 11 and 12 will be collectively referred to as a base station 10 below when not distinguished.

Each user terminal 20 is a terminal that supports various communication schemes such as LTE and LTE-A, and may include not only a mobile communication terminal (mobile station) but also a fixed communication terminal (fixed station).

The radio communication system 1 applies Orthogonal Frequency-Division Multiple Access (OFDMA) to downlink and applies Single Carrier-Frequency Division Multiple Access (SC-FDMA) and/or OFDMA to uplink as radio access schemes.

OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into bands including one or contiguous resource blocks per terminal and causes a plurality of terminals to use respectively different bands to reduce an inter-terminal interference. In this regard, uplink and downlink radio access schemes are not limited to a combination of these schemes, and other radio access schemes may be used.

The radio communication system 1 uses a downlink shared channel (PDSCH: Physical Downlink Shared Channel) shared by each user terminal 20, a broadcast channel (PBCH: Physical Broadcast Channel) and a downlink L1/L2 control channel as downlink channels. User data, higher layer control information and a System Information Block (SIB) are conveyed on the PDSCH. Furthermore, a Master Information Block (MIB) is conveyed on the PBCH.

The downlink L1/L2 control channel includes at least one of downlink control channels (a Physical Downlink Control Channel (PDCCH) and/or an Enhanced Physical Downlink Control Channel (EPDCCH)), a Physical Control Format Indicator Channel (PCFICH), and a Physical Hybrid-ARQ Indicator Channel (PHICH). Downlink Control Information (DCI) including scheduling information of the PDSCH and/or the PUSCH is conveyed on the PDCCH.

In addition, the scheduling information may be notified by the DCI. For example, DCI for scheduling DL data reception may be referred to as a DL assignment, and DCI for scheduling UL data transmission may be referred to as a UL grant.

The number of OFDM symbols used for the PDCCH is conveyed on the PCFICH. Transmission acknowledgement information (also referred to as, for example, retransmission control information, HARQ-ACK or ACK/NACK) of a Hybrid Automatic Repeat reQuest (HARQ) for the PUSCH is conveyed on the PHICH. The EPDCCH is subjected to frequency division multiplexing with the PDSCH (downlink shared data channel) and is used to convey DCI similar to the PDCCH.

The radio communication system 1 uses an uplink shared channel (PUSCH: Physical Uplink Shared Channel) shared by each user terminal 20, an uplink control channel (PUCCH: Physical Uplink Control Channel), and a random access channel (PRACH: Physical Random Access Channel) as uplink channels. User data and higher layer control information are conveyed on the PUSCH. Furthermore, downlink radio link quality information (CQI: Channel Quality Indicator), transmission acknowledgement information and a Scheduling Request (SR) are conveyed on the PUCCH. A random access preamble for establishing connection with a cell is conveyed on the PRACH.

The radio communication system 1 conveys a Cell-specific Reference Signal (CRS), a Channel State Information-Reference Signal (CSI-RS), a DeModulation Reference Signal (DMRS) and a Positioning Reference Signal (PRS) as downlink reference signals. Furthermore, the radio communication system 1 conveys a Sounding Reference Signal (SRS) and a DeModulation Reference Signal (DMRS) as uplink reference signals. In this regard, the DMRS may be referred to as a user terminal-specific reference signal (UE-specific reference signal). Furthermore, a reference signal to be conveyed is not limited to these.

### <Base Station>

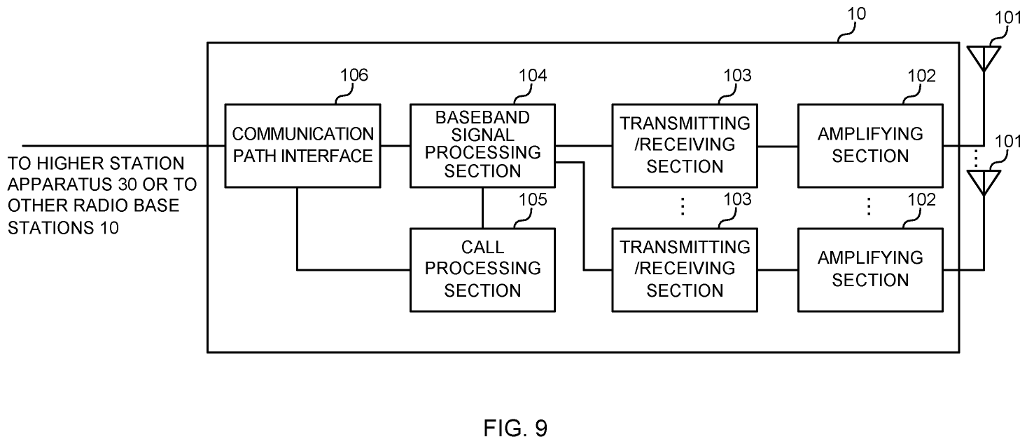

FIG. 9 is a diagram illustrating one example of an overall configuration of the base station according to the present embodiment. The base station 10 includes pluralities of transmission/reception antennas 101, amplifying sections 102 and transmitting/receiving sections 103, a baseband signal processing section 104, a call processing section 105 and a communication path interface 106. In this regard, the base station 10 only needs to be configured to include one or more of each of the transmission/reception antennas 101, the amplifying sections 102 and the transmitting/receiving sections 103.

User data transmitted from the base station 10 to the user terminal 20 on downlink is input from the higher station apparatus 30 to the baseband signal processing section 104 via the communication path interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., HARQ transmission processing), and transmission processing such as scheduling, transmission format selection, channel coding, Inverse Fast Fourier Transform (IFFT) processing, and precoding processing on the user data, and transfers the user data to each transmitting/receiving section 103. Furthermore, the baseband signal processing section 104 performs transmission processing such as channel coding and inverse fast

Fourier transform on a downlink control signal, too, and transfers the downlink control signal to each transmitting/receiving section 103.

Each transmitting/receiving section 103 converts a baseband signal precoded and output per antenna from the baseband signal processing section 104 into a radio frequency range, and transmits a radio frequency signal. The radio frequency signal subjected to frequency conversion by each transmitting/receiving section 103 is amplified by each amplifying section 102, and is transmitted from each transmission/reception antenna 101. The transmitting/receiving sections 103 can be composed of transmitters/receivers, transmission/reception circuits or transmission/reception apparatuses described based on a common knowledge in a technical field according to the present disclosure. In this regard, the transmitting/receiving sections 103 may be composed as an integrated transmitting/receiving section or may be composed of transmitting sections and receiving sections.

Meanwhile, each amplifying section 102 amplifies a radio frequency signal received by each transmission/reception antenna 101 as an uplink signal. Each transmitting/receiving section 103 receives the uplink signal amplified by each amplifying section 102. Each transmitting/receiving section 103 performs frequency conversion on the received signal into a baseband signal, and outputs the baseband signal to the baseband signal processing section 104.

The baseband signal processing section 104 performs Fast Fourier Transform (FFT) processing, Inverse Discrete Fourier Transform (IDFT) processing, error correcting decoding, MAC retransmission control reception processing, and reception processing of an RLC layer and a PDCP layer on user data included in the input uplink signal, and transfers the user data to the higher station apparatus 30 via the communication path interface 106. The call processing section 105 performs call processing (such as configuration and release) of a communication channel, state management of the base station 10 and radio resource management.

The communication path interface 106 transmits and receives signals to and from the higher station apparatus 30 via a given interface. Furthermore, the communication path interface 106 may transmit and receive (backhaul signaling) signals to and from the another base station 10 via an inter-base station interface (e.g., optical fibers compliant with the Common Public Radio Interface (CPRI) or the X2 interface).

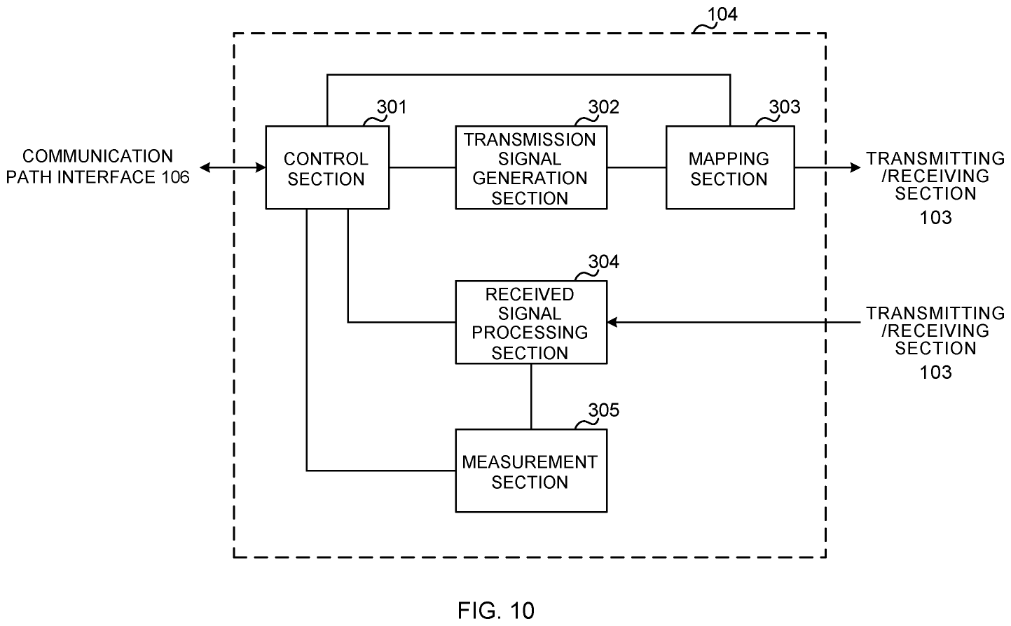

FIG. 10 is a diagram illustrating one example of a function configuration of the base station according to the present embodiment. In addition, this example mainly illustrates function blocks of characteristic portions according to the present embodiment, and may assume that the base station 10 includes other function blocks, too, that are necessary for radio communication.

The baseband signal processing section 104 includes at least the control section (scheduler) 301, a transmission signal generation section 302, a mapping section 303, a received signal processing section 304 and a measurement section 305. In addition, these components only need to be included in the base station 10, and part or all of the components may not be included in the baseband signal processing section 104.

The control section (scheduler) 301 controls the entire base station 10. The control section 301 can be composed of a controller, a control circuit or a control apparatus described based on the common knowledge in the technical field according to the present disclosure.

The control section 301 controls, for example, signal generation of the transmission signal generation section 302 and signal allocation of the mapping section 303. Furthermore, the control section 301 controls signal reception processing of the received signal processing section 304 and signal measurement of the measurement section 305.

The control section 301 controls scheduling (e.g., resource allocation) of system information, a downlink data signal (e.g., a signal that is transmitted on the PDSCH), and a downlink control signal (e.g., a signal that is transmitted on the PDCCH and/or the EPDCCH and is, for example, transmission acknowledgement information). Furthermore, the control section 301 controls generation of a downlink control signal and a downlink data signal based on a result obtained by deciding whether or not it is necessary to perform retransmission control on an uplink data signal.

The control section 301 controls scheduling of synchronization signals (e.g., PSS/SSS) and downlink reference signals (e.g., a CRS, a CSI-RS and a DMRS).

The transmission signal generation section 302 generates a downlink signal (such as a downlink control signal, a downlink data signal or a downlink reference signal) based on an instruction from the control section 301, and outputs the downlink signal to the mapping section 303. The transmission signal generation section 302 can be composed of a signal generator, a signal generating circuit or a signal generating apparatus described based on the common knowledge in the technical field according to the present disclosure.

The transmission signal generation section 302 generates, for example, a DL assignment for giving notification of downlink data allocation information, and/or a UL grant for giving notification of uplink data allocation information based on the instruction from the control section 301. The DL assignment and the UL grant are both DCI, and conform to a DCI format. Furthermore, the transmission signal generation section 302 performs encoding processing and modulation processing on the downlink data signal according to a code rate and a modulation scheme determined based on Channel State Information (CSI) from each user terminal 20.

The mapping section 303 maps the downlink signal generated by the transmission signal generation section 302, on given radio resources based on the instruction from the control section 301, and outputs the downlink signal to each transmitting/receiving section 103. The mapping section 303 can be composed of a mapper, a mapping circuit or a mapping apparatus described based on the common knowledge in the technical field according to the present disclosure.

The received signal processing section 304 performs reception processing (e.g., demapping, demodulation and decoding) on a received signal input from each transmitting/receiving section 103. In this regard, the received signal is, for example, an uplink signal (such as an uplink control signal, an uplink data signal or an uplink reference signal) transmitted from the user terminal 20. The received signal processing section 304 can be composed of a signal processor, a signal processing circuit or a signal processing apparatus described based on the common knowledge in the technical field according to the present disclosure.

The received signal processing section 304 outputs information decoded by the reception processing to the control section 301. When, for example, receiving the PUCCH including HARQ-ACK, the received signal processing section 304 outputs the HARQ-ACK to the control section 301. Furthermore, the received signal processing section 304 outputs the received signal and/or the signal after the reception processing to the measurement section 305.

The measurement section 305 performs measurement related to the received signal. The measurement section 305 can be composed of a measurement instrument, a measurement circuit or a measurement apparatus described based on the common knowledge in the technical field according to the present disclosure.

For example, the measurement section 305 may perform Radio Resource Management (RRM) measurement or Channel State Information (CSI) measurement based on the received signal. The measurement section 305 may measure received power (e.g., Reference Signal Received Power (RSRP)), received quality (e.g., Reference Signal Received Quality (RSRQ), a Signal to Interference plus Noise Ratio (SINR) or a Signal to Noise Ratio (SNR)), a signal strength (e.g., a Received Signal Strength Indicator (RSSI)) or channel information (e.g., CSI). The measurement section 305 may output a measurement result to the control section 301.

In addition, each transmitting/receiving section 103 may receive or transmit a Phase Tracking Reference Signal (PTRS). Furthermore, each transmitting/receiving section 103 transmits a downlink signal (e.g., a PDSCH, a PDCCH, DCI, a reference signal, a synchronization signal and so on), and receives an uplink signal (e.g., a PUSCH, a PUCCH, UCI and so on).

Furthermore, each transmitting/receiving section 103 may transmit various pieces of configuration information (e.g., PDSCH configuration information, PUSCH configuration information, SPS configuration information, configured grant configuration information, DMRS configuration information, downlink PTRS configuration information and uplink PTRS configuration information).

Furthermore, the control section 301 may determine a time density of the Phase Tracking Reference Signal (PTRS) based on a plurality of thresholds associated with at least one of a table used to determine at least one of a modulation order and a code rate of the downlink shared channel or the uplink shared channel and whether or not transform precoding is applied, and a Modulation and Coding Scheme (MCS) index in the downlink control information.

Furthermore, the control section 301 may determine the time density associated with the MCS index in the downlink control information by referring to a table that associates MCS index ranges and the time densities determined based on a plurality of these thresholds.

In this regard, a table (an MCS table or an MCS index table) used to determine at least one of the modulation order and the code rate may be one of a first table (e.g., FIG. 1) that supports modulation orders smaller than 6, a second table (e.g., FIG. 2) that supports modulation orders smaller than 8, and a third table (e.g., FIG. 3) whose at least one of code rates associated with the same modulation order is smaller than that in the first table.

Furthermore, the control section 301 may control dynamic switching of the above first to third tables. The control section 301 may determine at least one of the modulation order and the code rate of the downlink shared channel or the uplink shared channel based on one of the above first to third tables.

Furthermore, when a plurality of these thresholds are not configured by a higher layer signaling, the control section 301 may determine the time density as a given value.

### <User Terminal>

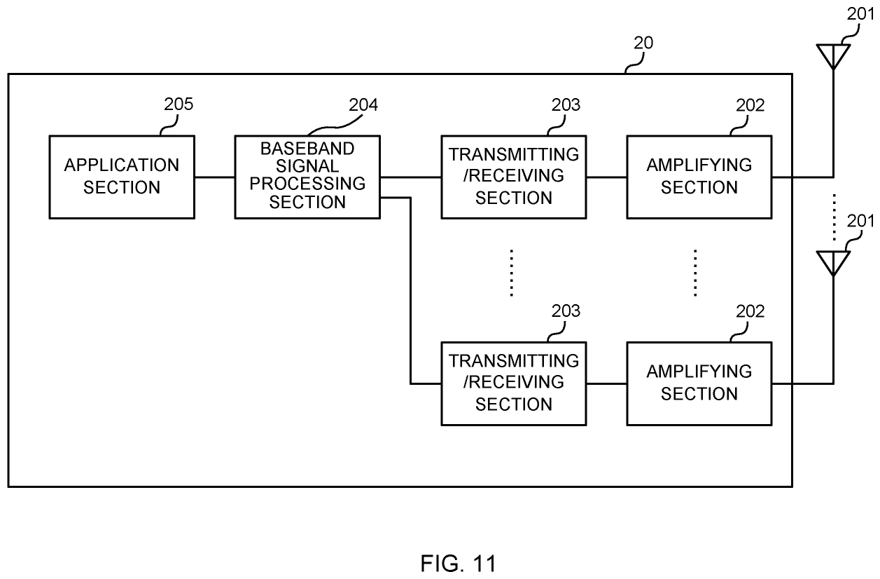

FIG. 11 is a diagram illustrating one example of an overall configuration of the user terminal according to the present embodiment. The user terminal 20 includes pluralities of transmission/reception antennas 201, amplifying sections 202 and transmitting/receiving sections 203, a baseband signal processing section 204 and an application section 205. In this regard, the user terminal 20 only needs to be configured to include one or more of each of the transmission/reception antennas 201, the amplifying sections 202 and the transmitting/receiving sections 203.

Each amplifying section 202 amplifies a radio frequency signal received at each transmission/reception antenna 201. Each transmitting/receiving section 203 receives a downlink signal amplified by each amplifying section 202. Each transmitting/receiving section 203 performs frequency conversion on the received signal into a baseband signal, and outputs the baseband signal to the baseband signal processing section 204. The transmitting/receiving sections 203 can be composed of transmitters/receivers, transmission/reception circuits or transmission/reception apparatuses described based on the common knowledge in the technical field according to the present disclosure. In this regard, the transmitting/receiving sections 203 may be composed as an integrated transmitting/receiving section or may be composed of transmitting sections and receiving sections.

The baseband signal processing section 204 performs FFT processing, error correcting decoding and retransmission control reception processing on the input baseband signal. The baseband signal processing section 204 transfers downlink user data to the application section 205. The application section 205 performs processing related to layers higher than a physical layer and an MAC layer. Furthermore, the baseband signal processing section 204 may transfer broadcast information of the downlink data, too, to the application section 205.

On the other hand, the application section 205 inputs uplink user data to the baseband signal processing section 204. The baseband signal processing section 204 performs retransmission control transmission processing (e.g., HARQ transmission processing), channel coding, precoding, transform precoding, Discrete Fourier Transform (DFT) processing and IFFT processing on the uplink user data, and transfers the uplink user data to each transmitting/receiving section 203.

Each transmitting/receiving section 203 converts the baseband signal output from the baseband signal processing section 204 into a radio frequency range, and transmits a radio frequency signal. The radio frequency signal subjected to the frequency conversion by each transmitting/receiving section 203 is amplified by each amplifying section 202, and is transmitted from each transmission/reception antenna 201.

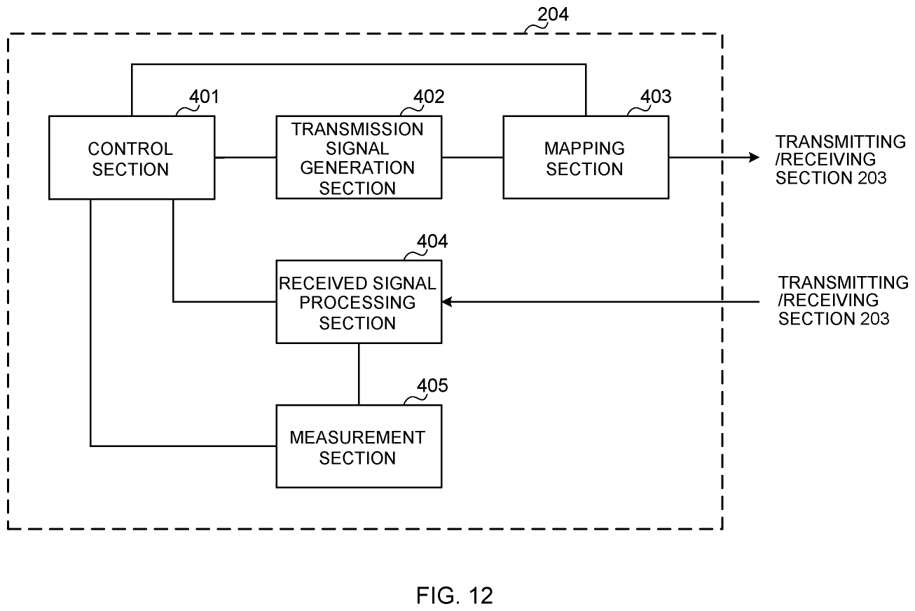

FIG. 12 is a diagram illustrating one example of a function configuration of the user terminal according to the present embodiment. In addition, this example mainly illustrates function blocks of characteristic portions according to the present embodiment, and may assume that the user terminal 20 includes other function blocks, too, that are necessary for radio communication.

The baseband signal processing section 204 of the user terminal 20 includes at least a control section 401, a transmission signal generation section 402, a mapping section 403, a received signal processing section 404 and a measurement section 405. In addition, these components only need to be included in the user terminal 20, and part or all of the components may not be included in the baseband signal processing section 204.

The control section 401 controls the entire user terminal 20. The control section 401 can be composed of a controller, a control circuit or a control apparatus described based on the common knowledge in the technical field according to the present disclosure.

The control section 401 controls, for example, signal generation of the transmission signal generation section 402 and signal allocation of the mapping section 403. Furthermore, the control section 401 controls signal reception processing of the received signal processing section 404 and signal measurement of the measurement section 405.

The control section 401 obtains from the received signal processing section 404 a downlink control signal and a downlink data signal transmitted from the base station 10. The control section 401 controls generation of an uplink control signal and/or an uplink data signal based on a result obtained by deciding whether or not it is necessary to perform retransmission control on the downlink control signal and/or the downlink data signal.

When obtaining from the received signal processing section 404 various pieces of information notified from the base station 10, the control section 401 may update parameters used for control based on the various pieces of information.

The transmission signal generation section 402 generates an uplink signal (such as an uplink control signal, an uplink data signal or an uplink reference signal) based on an instruction from the control section 401, and outputs the uplink signal to the mapping section 403. The transmission signal generation section 402 can be composed of a signal generator, a signal generating circuit or a signal generating apparatus described based on the common knowledge in the technical field according to the present disclosure.

The transmission signal generation section 402 generates, for example, an uplink control signal related to transmission acknowledgement information and Channel State Information (CSI) based on the instruction from the control section 401. Furthermore, the transmission signal generation section 402 generates an uplink data signal based on the instruction from the control section 401. When, for example, the downlink control signal notified from the base station 10 includes a UL grant, the transmission signal generation section 402 is instructed by the control section 401 to generate an uplink data signal.

The mapping section 403 maps the uplink signal generated by the transmission signal generation section 402, on radio resources based on the instruction from the control section 401, and outputs the uplink signal to each transmitting/receiving section 203. The mapping section 403 can be composed of a mapper, a mapping circuit or a mapping apparatus described based on the common knowledge in the technical field according to the present disclosure.

The received signal processing section 404 performs reception processing (e.g., demapping, demodulation and decoding) on the received signal input from each transmitting/receiving section 203. In this regard, the received signal is, for example, a downlink signal (such as a downlink control signal, a downlink data signal or a downlink reference signal) transmitted from the base station 10. The received signal processing section 404 can be composed of a signal processor, a signal processing circuit or a signal processing apparatus described based on the common knowledge in the technical field according to the present disclosure. Furthermore, the received signal processing section 404 can compose the receiving section according to the present disclosure.

The received signal processing section 404 outputs information decoded by the reception processing to the control section 401. The received signal processing section 404 outputs, for example, broadcast information, system information, an RRC signaling and DCI to the control section 401. Furthermore, the received signal processing section 404 outputs the received signal and/or the signal after the reception processing to the measurement section 405.

The measurement section 405 performs measurement related to the received signal. The measurement section 405 can be composed of a measurement instrument, a measurement circuit or a measurement apparatus described based on the common knowledge in the technical field according to the present disclosure.

For example, the measurement section 405 may perform RRM measurement or CSI measurement based on the received signal. The measurement section 405 may measure received power (e.g., RSRP), received quality (e.g., RSRQ, an SINR or an SNR), a signal strength (e.g., RSSI) or channel information (e.g., CSI). The measurement section 405 may output a measurement result to the control section 401.

In addition, each transmitting/receiving section 203 may receive or transmit the Phase Tracking Reference Signal (PTRS). Furthermore, each transmitting/receiving section 203 receives the downlink signal (e.g., the PDSCH, the PDCCH, the DCI, the reference signal, the synchronization signal and so on), and transmits the uplink signal (e.g., the PUSCH, the PUCCH, the UCI and so on).

Furthermore, each transmitting/receiving section 203 may receive the various pieces of configuration information (e.g., the PDSCH configuration information, the PUSCH configuration information, the SPS configuration information, the configured grant configuration information, the DMRS configuration information, the downlink PTRS configuration information and the uplink PTRS configuration information).

Furthermore, the control section 401 may determine the time density of the Phase Tracking Reference Signal (PTRS) based on a plurality of thresholds associated with at least one of the table used to determine at least one of the modulation order and the code rate of the downlink shared channel or the uplink shared channel and whether or not transform precoding is applied, and the Modulation and Coding Scheme (MCS) index in the downlink control information.

Furthermore, the control section 401 may determine the time density associated with the MCS index in the downlink control information by referring to the table that associates MCS index ranges and the time densities determined based on a plurality of these thresholds.

In this regard, the table (the MCS table or the MCS index table) used to determine at least one of the modulation order and the code rate may be one of the first table (e.g., FIG. 1) that supports the modulation orders smaller than 6, the second table (e.g., FIG. 2) that supports the modulation orders smaller than 8, and the third table (e.g., FIG. 3) whose at least one of the code rates associated with the same modulation order is smaller than that in the first table.

Furthermore, the control section 401 may control dynamic switching of the above first to third tables. The control section 401 may determine at least one of the modulation order and the code rate of the downlink shared channel or the uplink shared channel based on one of the above first to third tables.

Furthermore, when a plurality of these thresholds are not configured by a higher layer signaling, the control section 401 may determine the time density as a given value.

### (Hardware Configuration)

In addition, the block diagrams used to describe the above embodiment illustrate blocks in function units. These function blocks (components) are realized by an arbitrary combination of at least one of hardware and software. Furthermore, a method for realizing each function block is not limited in particular. That is, each function block may be realized by using one physically or logically coupled apparatus or may be realized by using a plurality of these apparatuses formed by connecting two or more physically or logically separate apparatuses directly or indirectly (by using, for example, wired connection or radio connection). Each function block may be implemented by combining software with the above one apparatus or a plurality of above apparatuses.

In this regard, the functions include judging, determining, deciding, calculating, computing, processing, deriving, investigating, looking up, ascertaining, receiving, transmitting, outputting, accessing, resolving, selecting, choosing, establishing, comparing, assuming, expecting, considering, broadcasting, notifying, communicating, forwarding, configuring, reconfiguring, allocating, mapping, and assigning, yet are not limited to these. For example, a function block (component) that causes transmission to function may be referred to as a transmitting unit or a transmitter. As described above, the method for realizing each function block is not limited in particular.

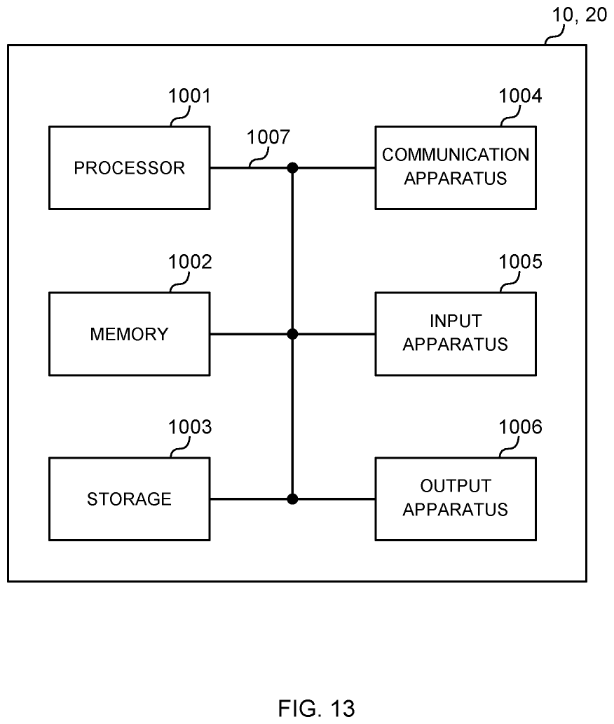

For example, the base station and the user terminal according to the present embodiment of the present disclosure may function as computers that perform processing of the radio communication method according to the present disclosure. FIG. 13 is a diagram illustrating one example of the hardware configurations of the base station and the user terminal according to the present embodiment. The above-described base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, a word “apparatus” in the following description can be read as a circuit, a device or a unit. The hardware configurations of the base station 10 and the user terminal 20 may be configured to include one or a plurality of apparatuses illustrated in FIG. 13 or may be configured without including part of the apparatuses.

For example, FIG. 13 illustrates the only one processor 1001. However, there may be a plurality of processors. Furthermore, processing may be executed by 1 processor or processing may be executed by 2 or more processors concurrently or successively or by using another method. In addition, the processor 1001 may be implemented by 1 or more chips.

Each function of the base station 10 and the user terminal 20 is realized by, for example, causing hardware such as the processor 1001 and the memory 1002 to read given software (program), and thereby causing the processor 1001 to perform an operation, and control communication via the communication apparatus 1004 and control at least one of reading and writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above-described baseband signal processing section 104 (204) and call processing section 105 may be realized by the processor 1001.

Furthermore, the processor 1001 reads programs (program codes), a software module or data from at least one of the storage 1003 and the communication apparatus 1004 out to the memory 1002, and executes various types of processing according to these programs, software module or data. As the programs, programs that cause the computer to execute at least part of the operations described in the above-described embodiment are used. For example, the control section 401 of the user terminal 20 may be realized by a control program that is stored in the memory 1002 and operates on the processor 1001, and other function blocks may be also realized likewise.

The memory 1002 is a computer-readable recording medium, and may be formed by at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus) and so on. The memory 1002 can store programs (program codes) and a software module that can be executed to perform the radio communication method according to the present embodiment of the present disclosure.

The storage 1003 is a computer-readable recording medium, and may be formed by at least one of, for example, a flexible disk, a floppy (registered trademark) disk, a magnetooptical disk (e.g., a compact disk (Compact Disc ROM (CD-ROM) and so on), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via at least one of a wired network and a radio network, and is also referred to as, for example, a network device, a network controller, a network card and a communication module. The communication apparatus 1004 may be configured to include a high frequency switch, a duplexer, a filter and a frequency synthesizer to realize at least one of, for example, Frequency Division Duplex (FDD) and Time Division Duplex (TDD). For example, the above-described transmission/reception antennas 101 (201), amplifying sections 102 (202), transmission/receiving sections 103 (203) and communication path interface 106 may be realized by the communication apparatus 1004. Each transmission/receiving section 103 may be physically or logically separately implemented as a transmitting section 103a and a receiving section 103b.

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using different buses between apparatuses.

Furthermore, the base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or entirety of each function block. For example, the processor 1001 may be implemented by using at least one of these hardware components.

### (Modified Example)

In addition, each term that has been described in the present disclosure and each term that is necessary to understand the present disclosure may be replaced with terms having identical or similar meanings. For example, at least one of a channel and a symbol may be a signal (signaling). Furthermore, a signal may be a message. A reference signal can be also abbreviated as an RS (Reference Signal), or may be referred to as a pilot or a pilot signal depending on standards to be applied. Furthermore, a Component Carrier (CC) may be referred to as a cell, a frequency carrier and a carrier frequency.

A radio frame may include one or a plurality of durations (frames) in a time domain. Each of one or a plurality of durations (frames) that makes up a radio frame may be referred to as a subframe. Furthermore, the subframe may include one or a plurality of slots in the time domain. The subframe may be a fixed time duration (e.g., 1 ms) that does not depend on the numerologies.

In this regard, the numerology may be a communication parameter to be applied to at least one of transmission and reception of a certain signal or channel. The numerology may indicate at least one of, for example, a SubCarrier Spacing (SCS), a bandwidth, a symbol length, a cyclic prefix length, a Transmission Time Interval (TTI), the number of symbols per TTI, a radio frame configuration, specific filtering processing performed by a transceiver in a frequency domain, and specific windowing processing performed by the transceiver in a time domain.

The slot may include one or a plurality of symbols (Orthogonal Frequency Division Multiplexing (OFDM) symbols or Single Carrier-Frequency Division Multiple Access (SC-FDMA) symbols) in the time domain. Furthermore, the slot may be a time unit based on the numerologies.

The slot may include a plurality of mini slots. Each mini slot may include one or a plurality of symbols in the time domain. Furthermore, the mini slot may be referred to as a subslot. The mini slot may include a smaller number of symbols than those of the slot. The PDSCH (or the PUSCH) to be transmitted in larger time units than that of the mini slot may be referred to as a PDSCH (PUSCH) mapping type A. The PDSCH (or the PUSCH) to be transmitted by using the mini slot may be referred to as a PDSCH (PUSCH) mapping type B.

The radio frame, the subframe, the slot, the mini slot and the symbol each indicate a time unit for conveying signals. The other corresponding names may be used for the radio frame, the subframe, the slot, the mini slot and the symbol. In addition, time units such as a frame, a subframe, a slot, a mini slot and a symbol in the present disclosure may be interchangeably read.

For example, 1 subframe may be referred to as a Transmission Time Interval (TTI), a plurality of contiguous subframes may be referred to as TTIs, or 1 slot or 1 mini slot may be referred to as a TTI. That is, at least one of the subframe and the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as a slot or a mini slot instead of a subframe.

In this regard, the TTI refers to, for example, a minimum time unit of scheduling of radio communication. For example, in the LTE system, the base station performs scheduling for allocating radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block or codeword, or may be a processing unit of scheduling or link adaptation. In addition, when the TTI is given, a time period (e.g., the number of symbols) in which a transport block, a code block or a codeword is actually mapped may be shorter than the TTI.

In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that make up a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe, a long subframe or a slot. A TTI shorter than the general TTI may be referred to as a reduced TTI, a short TTI, a partial or fractional TTI, a reduced subframe, a short subframe, a mini slot, a subslot or a slot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

A Resource Block (RB) is a resource allocation unit of the time domain and the frequency domain, and may include one or a plurality of contiguous subcarriers in the frequency domain. The numbers of subcarriers included in RBs may be the same irrespectively of a numerology, and may be, for example, 12. The numbers of subcarriers included in the RBs may be determined based on the numerology.

Furthermore, the RB may include one or a plurality of symbols in the time domain or may have the length of 1 slot, 1 mini slot, 1 subframe or 1 TTI. 1 TTI or 1 subframe may each include one or a plurality of resource blocks.

In this regard, one or a plurality of RBs may be referred to as a Physical Resource Block (PRB: Physical RB), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

A Bandwidth Part (BWP) (that may be referred to as a partial bandwidth) may mean a subset of contiguous common Resource Blocks (common RBs) for a certain numerology in a certain carrier. In this regard, the common RB may be specified by an RB index based on a common reference point of the certain carrier. A PRB may be defined based on a certain BWP, and may be numbered in the certain BWP.

The BWP may include a BWP for UL (UL BWP) and a BWP for DL (DL BWP). One or a plurality of BWPs in 1 carrier may be configured to the UE.

At least one of the configured BWPs may be active, and the UE may not assume that a given signal/channel is transmitted and received outside the active BWP. In addition, a “cell” and a “carrier” in the present disclosure may be read as a “BWP”.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and the parameters described in the present disclosure may be expressed by using absolute values, may be expressed by using relative values with respect to given values or may be expressed by using other corresponding information. For example, a radio resource may be instructed by a given index.

Names used for parameters in the present disclosure are in no respect restrictive names. Furthermore, numerical expressions that use these parameters may be different from those explicitly disclosed in the present disclosure. Various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive names.

The information and the signals described in the present disclosure may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or arbitrary combinations of these.

Furthermore, the information and the signals can be output at least one of from a higher layer to a lower layer and from the lower layer to the higher layer. The information and the signals may be input and output via a plurality of network nodes.

The input and output information and signals may be stored in a specific location (e.g., memory) or may be managed by using a management table. The information and signals to be input and output can be overridden, updated or additionally written. The output information and signals may be deleted. The input information and signals may be transmitted to other apparatuses.

Notification of information is not limited to the aspects/embodiment described in the present disclosure and may be performed by using other methods. For example, the information may be notified by a physical layer signaling (e.g., Downlink Control Information (DCI) and Uplink Control Information (UCI)), a higher layer signaling (e.g., a Radio Resource Control (RRC) signaling, broadcast information (a Master Information Block (MIB) and a System Information Block (SIB)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit notification, and may be given implicitly (by, for example, not giving notification of the given information or by giving notification of another information).

Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or is referred to as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using at least ones of wired techniques (e.g., coaxial cables, optical fiber cables, twisted pairs and Digital Subscriber Lines (DSLs)) and radio techniques (e.g., infrared rays and microwaves), at least ones of these wired techniques and radio techniques are included in a definition of the transmission media.

The terms “system” and “network” used in the present disclosure can be interchangeably used.

In the present disclosure, terms such as “precoding”, a “precoder”, a “weight (precoding weight)”, “Quasi-Co-Location (QCL)”, “transmission power”, “phase rotation”, an “antenna port”, an “antenna port group”, a “layer”, “the number of layers”, a “rank”, a “beam”, a “beam width”, a “beam angle”, an “antenna”, an “antenna element” and a “panel” and so on can be interchangeably used.

In the present disclosure, terms such as a “base Station (BS)”, a “radio base station”, a “fixed station”, a “NodeB”, an “eNodeB (eNB)”, a “gNodeB (gNB)”, an “access point”, a “Transmission Point (TP)”, a “Reception Point (RP)”, a “Transmission/Reception Point (TRP)”, a “panel”, a “cell”, a “sector”, a “cell group”, a “carrier” and a “component carrier” can be interchangeably used. The base station is also referred to as terms such as a macro cell, a small cell, a femtocell or a picocell.

The base station can accommodate one or a plurality of (e.g., three) cells. When the base station accommodates a plurality of cells, an entire coverage area of the base station can be partitioned into a plurality of smaller areas. Each smaller area can also provide a communication service via a base station subsystem (e.g., indoor small base station (RRH: Remote Radio Head)). The term “cell” or “sector” indicates part or the entirety of the coverage area of at least one of the base station and the base station subsystem that provide a communication service in this coverage.

In the present disclosure, the terms such as “Mobile Station (MS)”, “user terminal”, “user apparatus (UE: User Equipment)” and “terminal” can be interchangeably used.

The mobile station is also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

At least one of the base station and the mobile station may be referred to as a transmission apparatus, a reception apparatus or a communication apparatus. In addition, at least one of the base station and the mobile station may be a device mounted on a movable body or the movable body itself. The movable body may be a vehicle (e.g., a car or an airplane), may be a movable body (e.g., a drone or a self-driving car) that moves unmanned or may be a robot (a manned type or an unmanned type). In addition, at least one of the base station and the mobile station includes an apparatus, too, that does not necessarily move during a communication operation. For example, at least one of the base station and the mobile station may be an Internet of Things (IoT) device such as a sensor.

Furthermore, the base station in the present disclosure may be read as the user terminal.

For example, each aspect/embodiment of the present disclosure may be applied to a configuration where communication between the base station and the user terminal is replaced with communication between a plurality of user terminals (that may be referred to as, for example, Device-to-Device (D2D) or Vehicle-to-Everything (V2X)). In this case, the user terminal 20 may be configured to include the functions of the above-described base station 10. Furthermore, words such as “uplink” and “downlink” may be read as a word (e.g., a “side”) that matches terminal-to-terminal communication. For example, the uplink channel and the downlink channel may be read as side channels.

Similarly, the user terminal in the present disclosure may be read as the base station. In this case, the base station 10 may be configured to include the functions of the above-described user terminal 20.

In the present disclosure, operations performed by the base station are performed by an upper node of this base station depending on cases. Obviously, in a network including one or a plurality of network nodes including the base stations, various operations performed to communicate with a terminal can be performed by base stations, one or more network nodes (that are regarded as, for example, Mobility Management Entities (MMEs) or Serving-Gateways (S-GWs), yet are not limited to these) other than the base stations or a combination of these.

Each aspect/embodiment described in the present disclosure may be used alone, may be used in combination or may be switched and used when carried out. Furthermore, orders of the processing procedures, the sequences and the flowchart according to each aspect/embodiment described in the present disclosure may be rearranged unless contradictions arise. For example, the method described in the present disclosure presents various step elements by using an exemplary order and is not limited to the presented specific order.

Each aspect/embodiment described in the present disclosure may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New Radio Access Technology (New-RAT), New Radio (NR), New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideB and (UWB), Bluetooth (registered trademark), systems that use other appropriate radio communication methods, or next-generation systems that are expanded based on these systems. Furthermore, a plurality of systems may be combined (e.g., a combination of LTE or LTE-A and 5G) and applied.

The phrase “based on” used in the present disclosure does not mean “based only on” unless specified otherwise. In other words, the phrase “based on” means both of “based only on” and “based at least on”.

Every reference to elements that use names such as “first” and “second” used in the present disclosure does not generally limit the quantity or the order of these elements. These names can be used in the present disclosure as a convenient method for distinguishing between two or more elements. Hence, the reference to the first and second elements does not mean that only two elements can be employed or the first element should precede the second element in some way.

The term “deciding (determining)” used in the present disclosure includes diverse operations in some cases. For example, “deciding (determining)” may be regarded to “decide (determine)” judging, calculating, computing, processing, deriving, investigating, looking up, search and inquiry (e.g., looking up in a table, a database or another data structure), and ascertaining.

Furthermore, “deciding (determining)” may be regarded to “decide (determine)” receiving (e.g., receiving information), transmitting (e.g., transmitting information), input, output and accessing (e.g., accessing data in a memory).

Furthermore, “deciding (determining)” may be regarded to “decide (determine)” resolving, selecting, choosing, establishing and comparing. That is, “deciding (determining)” may be regarded to “decide (determine)” some operation.

Furthermore, “deciding (determining)” may be read as “assuming”, “expecting” and “considering”.

“Maximum transmit power” disclosed in the present disclosure may mean a maximum value of transmit power, may mean the nominal UE maximum transmit power, or may mean the rated UE maximum transmit power.

The words “connected” and “coupled” used in the present disclosure or every modification of these words can mean every direct or indirect connection or coupling between 2 or more elements, and can include that 1 or more intermediate elements exist between the two elements “connected” or “coupled” with each other. The elements may be coupled or connected physically or logically or by a combination of these physical and logical connections. For example, “connection” may be read as “access”.

It can be understood in the present disclosure that, when connected, the two elements are “connected” or “coupled” with each other by using 1 or more electric wires, cables or printed electrical connection, and by using electromagnetic energy having wavelengths in radio frequency domains, microwave domains or (both of visible and invisible) light domains in some non-restrictive and non-comprehensive examples.

A sentence that “A and B are different” in the present disclosure may mean that “A and B are different from each other”. In this regard, the sentence may mean that “A and B are each different from C”. Words such as “separate” and “coupled” may be also interpreted in a similar way to “different”.

When the words “include” and “including” and modifications of these words are used in the present disclosure, these words intend to be comprehensive similar to the word “comprising”. Furthermore, the word “or” used in the present disclosure intends not to be an exclusive OR.

When, for example, translation adds articles such as a, an and the in English in the present disclosure, the present disclosure may include that nouns coming after these articles are plural.

The invention according to the present disclosure has been described in detail above. However, it is obvious for a person skilled in the art that the invention according to the present disclosure is not limited to the embodiment described in the present disclosure. The invention according to the present disclosure can be carried out as modified and changed aspects without departing from the gist and the scope of the invention defined based on the recitation of the claims. Accordingly, the description of the present disclosure is intended for exemplary explanation, and does not bring any restrictive meaning to the invention according to the present disclosure.

1. A user terminal comprising:
a receiving section that receives downlink control information for scheduling a downlink shared channel or an uplink shared channel; and
a control section that determines a time density of a Phase Tracking Reference Signal (PTRS) based on a plurality of thresholds and a Modulation and Coding Scheme (MCS) index in the downlink control information, wherein the plurality of thresholds is associated with at least one of a table and whether or not transform precoding is applied, and the table is used to determine at least one of a modulation order and a code rate of the downlink shared channel or the uplink shared channel.

2. The user terminal according to claim 1, wherein the control section determines the time density associated with the MCS index in the downlink control information by referring to a table that associates a range of an MCS index and the time density determined based on the plurality of thresholds.

3. The user terminal according to claim 1, wherein the table used to determine at least one of the modulation order and the code rate is one of a first table that supports a modulation order smaller than 6, a second table that supports a modulation order smaller than 8, and a third table whose at least one of code rates associated with a same modulation order is smaller than a code rate of the first table.

4. The user terminal according to claim 1, wherein the receiving section receives the plurality of thresholds by a higher layer signaling.

5. The user terminal according to claim 1, wherein, when the plurality of thresholds are not configured by a higher layer signaling, the control section determines the time density as a given value.

6. A radio communication method comprising:
receiving downlink control information for scheduling a downlink shared channel or an uplink shared channel; and
determining a time density of a Phase Tracking Reference Signal (PTRS) based on a plurality of thresholds and a Modulation and Coding Scheme (MCS) index in the downlink control information, wherein the plurality of thresholds is associated with at least one of a table and whether or not transform precoding is applied, and the table is used to determine at least one of a modulation order and a code rate of the downlink shared channel or the uplink shared channel.

7. The user terminal according to claim 2, wherein the table used to determine at least one of the modulation order and the code rate is one of a first table that supports a modulation order smaller than 6, a second table that supports a modulation order smaller than 8, and a third table whose at least one of code rates associated with a same modulation order is smaller than a code rate of the first table.

8. The user terminal according to claim 2, wherein the receiving section receives the plurality of thresholds by a higher layer signaling.

9. The user terminal according to claim 3, wherein the receiving section receives the plurality of thresholds by a higher layer signaling.

10. The user terminal according to claim 2, wherein, when the plurality of thresholds are not configured by a higher layer signaling, the control section determines the time density as a given value.

11. The user terminal according to claim 3, wherein, when the plurality of thresholds are not configured by a higher layer signaling, the control section determines the time density as a given value.
